(19) United States
(12) Patent Application Publication
(10) Pub. No.: US 2024/0064796 A1
(43) Pub. Date: Feb. 22, 2024

(54) PRIORITY FOR HALF-DUPLEX USER EQUIPMENT

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US); Abdelrahman Mohamed Ahmed Mohamed IBRAHIM, San Diego, CA (US); Ahmed Attia ABOTABL, San Diego, CA (US); Yan ZHOU, San Diego, CA (US); Peter GAAL, San Diego, CA (US)

(21) Appl. No.: 17/820,991

(22) Filed: Aug. 19, 2022

(51) Int. Cl. H04W 72/12; H04L 5/16; H04L 5/00

(52) U.S. Cl. CPC H04W 72/1242; H04L 5/16; H04L 5/0094

(57) ABSTRACT

Various aspects of the present disclosure generally relate to wireless communication. In some aspects, a user equipment (UE) may transmit capability information indicating that the UE has a capability for an intra-band conflict resolution rule for resolving a conflict, in one or more symbols, between a first communication on a first semi-statically configured resource of a first cell and a second resource on a second cell according to a first priority of the first communication, wherein the first semi-statically configured resource is associated with a first link direction and the second resource is associated with a second link direction different than the first link direction. The UE may perform at least one of the first communication or the second communication according to the intra-band conflict resolution rule. Numerous other aspects are described.

### INTRODUCTION

Aspects of the present disclosure generally relate to wireless communication and to techniques and apparatuses for priority for a user equipment (UE).

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a UE or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting capability information indicating that the UE has a capability for an intra-band conflict resolution rule for resolving a conflict, in at least one symbol, between a first communication on a first semi-statically configured resource of a first cell and a second resource on a second cell based at least in part on a first priority of the first communication, the first semi-statically configured resource having a first link direction and the second resource having a second link direction different than the first link direction. The method may include performing at least one of the first communication or a second communication on the second resource according to the intra-band conflict resolution rule.

Some aspects described herein relate to a method of wireless communication performed by a user equipment (UE). The method may include receiving information indicating a first resource for measurement of a synchronization signal block (SSB) on a first cell, wherein the first resource at least partially overlaps with a second resource, on a second cell belonging to a same band as the first cell, indicated for an uplink transmission of the UE. The method may include transmitting, in half-duplex, the uplink transmission on the second resource.

Some aspects described herein relate to a method of wireless communication performed by a network node. The method may include obtaining capability information indicating that a user equipment (UE) has a capability for an intra-band conflict resolution rule for resolving a conflict, in at least one symbol, between a first communication on a first semi-statically configured resource of a first cell and a second resource on a second cell based at least in part on a first priority of the first communication, the first semi-statically configured resource having a first link direction and the second resource having a second link direction different than the first link direction. The method may include performing at least one of the first communication or a second communication on the second resource according to the intra-band conflict resolution rule.

Some aspects described herein relate to a method of wireless communication performed by a network node. The method may include outputting information indicating a first resource for measurement of a synchronization signal block (SSB) on a first cell, wherein the first resource at least partially overlaps with a second resource, on a second cell belonging to a same band as the first cell, indicated for an uplink transmission of a user equipment (UE). The method may include obtaining the uplink transmission on the second resource.

Some aspects described herein relate to a user equipment (UE) for wireless communication. The user equipment may include a memory and one or more processors coupled to the memory. The one or more processors may be configured to transmit capability information indicating that the UE has a capability for an intra-band conflict resolution rule for resolving a conflict, in at least one symbol, between a first communication on a first semi-statically configured resource of a first cell and a second resource on a second cell based at least in part on a first priority of the first communication, the first semi-statically configured resource having a first link direction and the second resource having a second link direction different than the first link direction. The one or more processors may be configured to perform at least one of the first communication or a second communication on the second resource according to the intra-band conflict resolution rule.

Some aspects described herein relate to a user equipment (UE) for wireless communication. The user equipment may include a memory and one or more processors coupled to the memory. The one or more processors may be configured to receive information indicating a first resource for measurement of a synchronization signal block (SSB) on a first cell, wherein the first resource at least partially overlaps with a second resource, on a second cell belonging to a same band as the first cell, indicated for an uplink transmission of the UE. The one or more processors may be configured to transmit, in half-duplex, the uplink transmission on the second resource.

Some aspects described herein relate to a network node for wireless communication. The network node may include a memory and one or more processors coupled to the memory. The one or more processors may be configured to obtain capability information indicating that a user equipment (UE) has a capability for an intra-band conflict resolution rule for resolving a conflict, in at least one symbol, between a first communication on a first semi-statically configured resource of a first cell and a second resource on a second cell based at least in part on a first priority of the first communication, the first semi-statically configured resource having a first link direction and the second resource having a second link direction different than the first link direction. The one or more processors may be configured to perform at least one of the first communication or a second communication on the second resource according to the intra-band conflict resolution rule.

Some aspects described herein relate to a network node for wireless communication. The network node may include a memory and one or more processors coupled to the memory. The one or more processors may be configured to output information indicating a first resource for measurement of a synchronization signal block (SSB) on a first cell, wherein the first resource at least partially overlaps with a second resource, on a second cell belonging to a same band as the first cell, indicated for an uplink transmission of a user equipment (UE). The one or more processors may be configured to obtain the uplink transmission on the second resource.

Some aspects described herein relate to a non-transitory computer-readable medium that stores a set of instructions for wireless communication by a user equipment (UE). The set of instructions, when executed by one or more processors of the UE, may cause the UE to transmit capability information indicating that the UE has a capability for an intra-band conflict resolution rule for resolving a conflict, in at least one symbol, between a first communication on a first semi-statically configured resource of a first cell and a second resource on a second cell based at least in part on a first priority of the first communication, the first semi-statically configured resource having a first link direction and the second resource having a second link direction different than the first link direction. The set of instructions, when executed by one or more processors of the UE, may cause the UE to perform at least one of the first communication or a second communication on the second resource according to the intra-band conflict resolution rule.

Some aspects described herein relate to a non-transitory computer-readable medium that stores a set of instructions for wireless communication by a one or more instructions that, when executed by one or more processors of an UE. The set of instructions, when executed by one or more processors of the one or more instructions that, when executed by one or more processors of an UE, may cause the one or more instructions that, when executed by one or more processors of an UE to receive information indicating a first resource for measurement of a synchronization signal block (SSB) on a first cell, wherein the first resource at least partially overlaps with a second resource, on a second cell belonging to a same band as the first cell, indicated for an uplink transmission of the UE. The set of instructions, when executed by one or more processors of the one or more instructions that, when executed by one or more processors of an UE, may cause the one or more instructions that, when executed by one or more processors of an UE to transmit, in half-duplex, the uplink transmission on the second resource.

Some aspects described herein relate to a non-transitory computer-readable medium that stores a set of instructions for wireless communication by a network node. The set of instructions, when executed by one or more processors of the network node, may cause the network node to obtain capability information indicating that a user equipment (UE) has a capability for an intra-band conflict resolution rule for resolving a conflict, in at least one symbol, between a first communication on a first semi-statically configured resource of a first cell and a second resource on a second cell based at least in part on a first priority of the first communication, the first semi-statically configured resource having a first link direction and the second resource having a second link direction different than the first link direction. The set of instructions, when executed by one or more processors of the network node, may cause the network node to perform at least one of the first communication or a second communication on the second resource according to the intra-band conflict resolution rule.

Some aspects described herein relate to a non-transitory computer-readable medium that stores a set of instructions for wireless communication by a network node. The set of instructions, when executed by one or more processors of the network node, may cause the network node to output information indicating a first resource for measurement of a synchronization signal block (SSB) on a first cell, wherein the first resource at least partially overlaps with a second resource, on a second cell belonging to a same band as the first cell, indicated for an uplink transmission of a user equipment (UE). The set of instructions, when executed by one or more processors of the network node, may cause the network node to obtain the uplink transmission on the second resource.

Some aspects described herein relate to an apparatus for wireless communication. The apparatus may include means for transmitting capability information indicating that the apparatus has a capability for an intra-band conflict resolution rule for resolving a conflict, in at least one symbol, between a first communication on a first semi-statically configured resource of a first cell and a second resource on a second cell based at least in part on a first priority of the first communication, the first semi-statically configured resource having a first link direction and the second resource having a second link direction different than the first link direction. The apparatus may include means for performing at least one of the first communication or a second communication on the second resource according to the intra-band conflict resolution rule.

Some aspects described herein relate to an apparatus for wireless communication. The apparatus may include means for receiving information indicating a first resource for measurement of a synchronization signal block (SSB) on a first cell, wherein the first resource at least partially overlaps with a second resource, on a second cell belonging to a same band as the first cell, indicated for an uplink transmission of the apparatus. The apparatus may include means for transmitting, in half-duplex, the uplink transmission on the second resource.

Some aspects described herein relate to an apparatus for wireless communication. The apparatus may include means for obtaining capability information indicating that a user equipment (UE) has a capability for an intra-band conflict resolution rule for resolving a conflict, in at least one symbol, between a first communication on a first semi-statically configured resource of a first cell and a second resource on a second cell based at least in part on a first priority of the first communication, the first semi-statically configured resource having a first link direction and the second resource having a second link direction different than the first link direction. The apparatus may include means for performing at least one of the first communication or a second communication on the second resource according to the intra-band conflict resolution rule.

Some aspects described herein relate to an apparatus for wireless communication. The apparatus may include means for outputting information indicating a first resource for measurement of a synchronization signal block (SSB) on a first cell, wherein the first resource at least partially overlaps with a second resource, on a second cell belonging to a same band as the first cell, indicated for an uplink transmission of a user equipment (UE). The apparatus may include means for obtaining the uplink transmission on the second resource.

Aspects generally include a method, apparatus, system, computer program product, non-transitory computer-readable medium, user equipment, base station, network entity, network node, wireless communication device, and/or processing system as substantially described with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of full-duplex communication in a wireless network, in accordance with the present disclosure.

FIG. 5 is a diagram illustrating an example of sub-band full duplex (SBFD) schemes, in accordance with the present disclosure.

FIG. 6 is a diagram illustrating an example of conflict resolution using an intra-band conflict resolution rule, in accordance with the present disclosure.

FIGS. 7 and 8 are diagrams illustrating examples of applying a conflict resolution rule, in accordance with the present disclosure.

FIG. 9 is a diagram illustrating an example of signaling associated with a relaxed restriction on uplink transmission overlapping with an SSB reception, in accordance with the present disclosure.

FIG. 10 is a diagram illustrating an example process performed, for example, by a UE, in accordance with the present disclosure.

FIG. 11 is a diagram illustrating an example process performed, for example, by a UE, in accordance with the present disclosure.

FIG. 12 is a diagram of an example apparatus for wireless communication, in accordance with the present disclosure.

FIG. 13 is a diagram illustrating an example of a hardware implementation for an apparatus employing a processing system, in accordance with the present disclosure.

FIG. 14 is a diagram illustrating an example of an implementation of code and circuitry for an apparatus, in accordance with the present disclosure.

FIG. 15 is a diagram illustrating an example process performed, for example, by a network node, in accordance with the present disclosure.

FIG. 16 is a diagram illustrating an example process performed, for example, by a network node, in accordance with the present disclosure.

FIG. 17 is a diagram of an example apparatus for wireless communication, in accordance with the present disclosure.

FIG. 18 is a diagram illustrating an example of a hardware implementation for an apparatus employing a processing system, in accordance with the present disclosure.

FIG. 19 is a diagram illustrating an example of an implementation of code and circuitry for an apparatus, in accordance with the present disclosure.

### DETAILED DESCRIPTION

A network node (such as a network node of a 5G network) may communicate with a user equipment (UE) via uplink communications (which are communications from the UE to the network node) and downlink communications (which are communications from the network node to the UE). These communications can be half-duplex communications or full-duplex communications. Half-duplex communication is communication in only one link direction (where a link direction is an uplink direction or a downlink direction). Full-duplex communication is communication in both the uplink direction and the downlink direction. For example, full-duplex communication may involve an uplink communication and a downlink communication, wherein the uplink communication and the downlink communication are at least partially overlapped in the time domain and/or the frequency domain. Half-duplex communication is simpler to implement than full-duplex communication. Full-duplex communication provides more efficient spectral usage than half-duplex communication but requires a more sophisticated receiver than half-duplex communication, since the receiver must account for interference between an overlapped transmission and reception.

In some examples, full-duplex communication can be implemented within a carrier or across multiple carriers of a band. A carrier is a configured set of frequencies (e.g., resource blocks) in which a UE can communicate with a network node. One example of a carrier is a component carrier of a carrier aggregation configuration. A carrier may be referred to, interchangeably herein, as a cell. Full-duplex communication can be implemented in a carrier, for example, using a sub-band full-duplex (SBFD) scheme. In an SBFD scheme, a carrier is subdivided into sub-bands, where a sub-band is a set of resource blocks (which may or may not be contiguous with one another) of a carrier. In an SBFD scheme, in a given time resource (e.g., a slot, a symbol, a group of slots), a first sub-band can be configured for uplink communication and a second sub-band can be configured for downlink communication. In some examples, a UE may perform half-duplex communication in the given time resource, while a network node performs full-duplex communication. For example, a first UE may utilize only the first sub-band for communication with the network node and a second UE may utilize only the second sub-band for communication with the network node. Thus, a network node having a capability for the SBFD scheme can improve utilization of frequency resources relative to using a separate carrier for communication with each UE. Furthermore, SBFD schemes can be implemented across two or more carriers, such that, in a given time resource, a first carrier (or group of carriers) is configured for downlink communication and a second carrier (or group of carriers) is configured for uplink communication.

Resources (e.g., frequency resources and time resources) can be configured for uplink communication or downlink communication in a variety of ways. For example, a resource can be semi-statically configured, such as by radio resource control (RRC) signaling of a reference signal configuration, a semi-persistent scheduling (SPS) configuration, a configured grant, a control channel configuration, or a random access configuration, for communication of a physical downlink shared channel (PDSCH), a physical downlink control channel (PDCCH), a channel state information reference signal (CSI-RS), a sounding reference signal (SRS), a physical uplink shared channel (PUSCH), a physical uplink control channel (PUCCH), or a physical random access (PRACH). As another example, a resource can be configured via an RRC parameter, such as a TDD configuration including a cell-common parameter (e.g., tdd-UL-DL-ConfigurationCommon) or a dedicated parameter (e.g., (e.g., tdd-UL-DL-ConfigurationDedicated), that indicates whether the resource can be used for uplink communication or for downlink communication.

A UE may communicate using multiple carriers (equivalently, multiple cells). In some cases, a conflict may arise between a communication or a resource on a first carrier and a communication or a resource on a second carrier. For example, one or more symbols of an uplink communication on the first carrier may overlap in time with a downlink communication, or a resource configured for downlink communication, on the second carrier. As another example, a downlink communication on the first carrier may overlap in time with an uplink communication, or a resource configured for uplink communication, on the second carrier. If the UE is capable of only half-duplex communication, then the UE cannot concurrently transmit an uplink communication and receive a downlink communication. Furthermore, if an uplink communication overlaps with a downlink resource on a second carrier, a scenario may arise in which the UE is scheduled with a downlink communication on the downlink resource overlapping with the uplink communication. Rules have been proposed to resolve such conflicts at the UE. However, these rules have traditionally been based on how a given resource is configured (semi-statically for transmission or reception of a communication, via cell-common or dedicated RRC signaling, or dynamically). These rules may not take into account priority of the resources or communications involved in the collision. For example, such a rule may lead to the cancellation of a scheduled or configured communication because the scheduled or configured communication overlaps with a resource on a different cell that is configured for a different link direction than the scheduled communication, irrespective of a priority of the scheduled or configured communication. As another example, such a rule may lead to a UE being disallowed to transmit an uplink transmission on a resource overlapping with a synchronization signal block (SSB) resource on a different cell. An SSB is a reference signal (or group of reference signals) used, among other things, for synchronization to a cell. If the UE acquires the SSB on a cell other than the different cell, then there may be no benefit to the UE skipping transmission of the uplink transmission on the resource overlapping with the SSB resource on the different cell, and communication resources may be inefficiently allocated.

Some techniques described herein provide signaling of a capability (such as UE capability information) for an intra-band conflict resolution rule for resolving a conflict between communications or resources on different cells associated with a same band, according to one or more priorities of the communications or resources. Capability information is a communication indicating features and parameters usable for communication or operation of a UE. The intra-band conflict resolution rule may indicate which communication should be performed or which resource should be utilized (and/or which resource or communication should be dropped or skipped) according to the priorities. Thus, utilization of network resources and efficiency and reliability of communications of the UE are improved.

Some techniques described herein provide resolution of a conflict between a resource for measurement of an SSB on a first cell, and a resource on a second cell belonging to the same band as the first cell, indicated for an uplink transmission of the UE. For example, if the UE has already acquired (e.g., measured) an SSB associated with the same SSB index as the SSB, the UE may perform the uplink transmission and/or skip measurement (e.g., acquisition) of the SSB. Thus, efficiency of uplink communication of the UE is improved.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

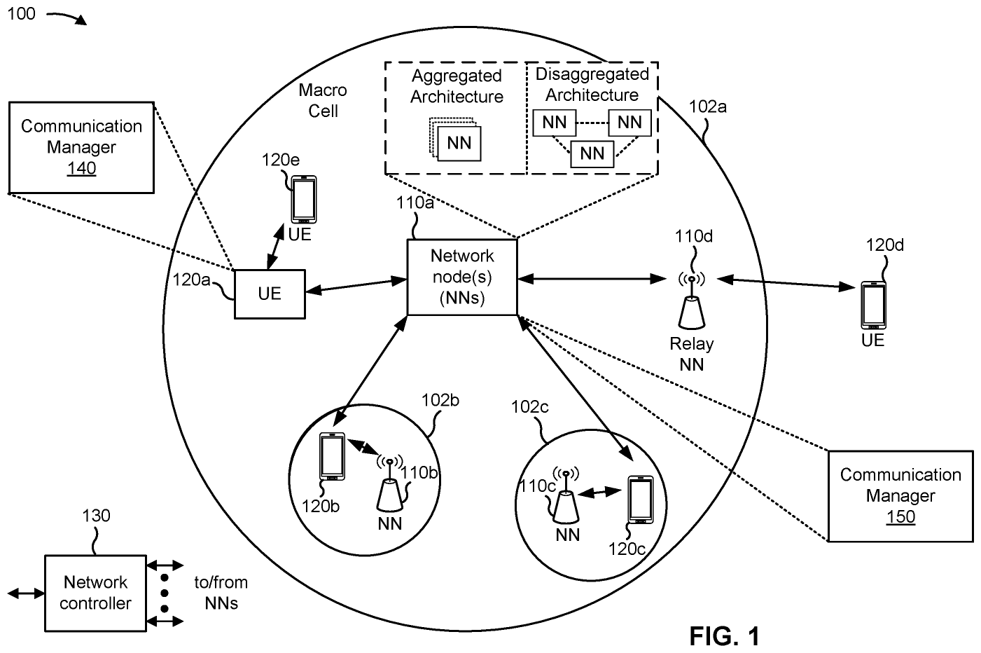

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

The electromagnetic spectrum is often subdivided, by frequency/wavelength, into various classes, bands, channels, etc. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit capability information indicating that the UE has a capability for an intra-band conflict resolution rule for resolving a conflict between one or more symbols of a first communication on a first semi-statically configured resource of a first cell and a second resource on a second cell based at least in part on a first priority of the first communication; and perform at least one of the first communication or the second communication according to the intra-band conflict resolution rule. As described in more detail elsewhere herein, the communication manager 140 may receive information indicating a first resource for measurement of an SSB on a first cell, wherein the first resource at least partially overlaps with a second resource, on a second cell belonging to a same band as the first cell, indicated for an uplink transmission of the UE; and transmit, in half-duplex, the uplink transmission on the second resource. Additionally, or alternatively, the communication manager 140 may perform one or more other operations described herein.

In some aspects, the network node may include a communication manager 150. As described in more detail elsewhere herein, the communication manager 150 may obtain capability information indicating a capability for an intra-band conflict resolution rule for resolving a conflict between one or more symbols of a first communication on a first semi-statically configured resource of a first cell and a second resource on a second cell according to a first priority of the first communication; and perform at least one of the first communication or a second communication according to the intra-band conflict resolution rule. As described in more detail elsewhere herein, the communication manager 150 may output information indicating a first resource for measurement of a synchronization signal block (SSB) on a first cell, wherein the first resource at least partially overlaps with a second resource, on a second cell belonging to a same band as the first cell, indicated for an uplink transmission of a user equipment (UE); and obtain the uplink transmission on the second resource. Additionally, or alternatively, the communication manager 150 may perform one or more other operations described herein.

As indicated above, FIG. 1 is provided as an example. Other examples may differ from what is described with regard to FIG. 1.

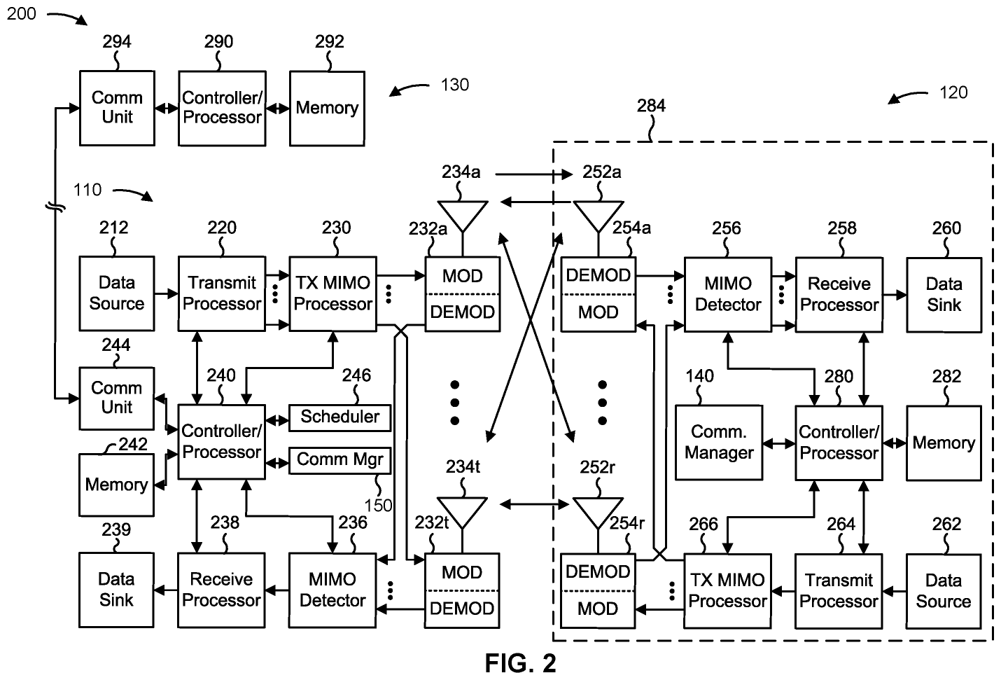

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein.

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein.

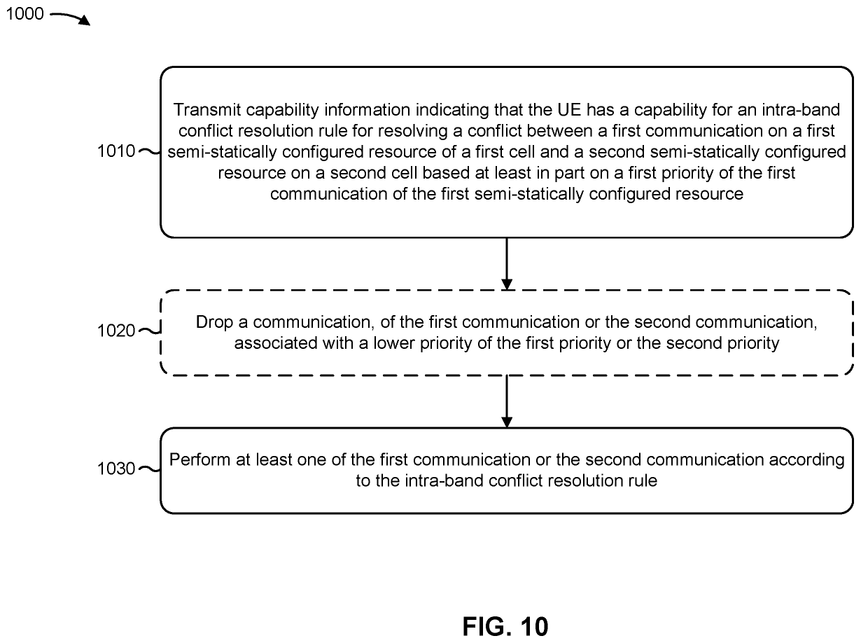

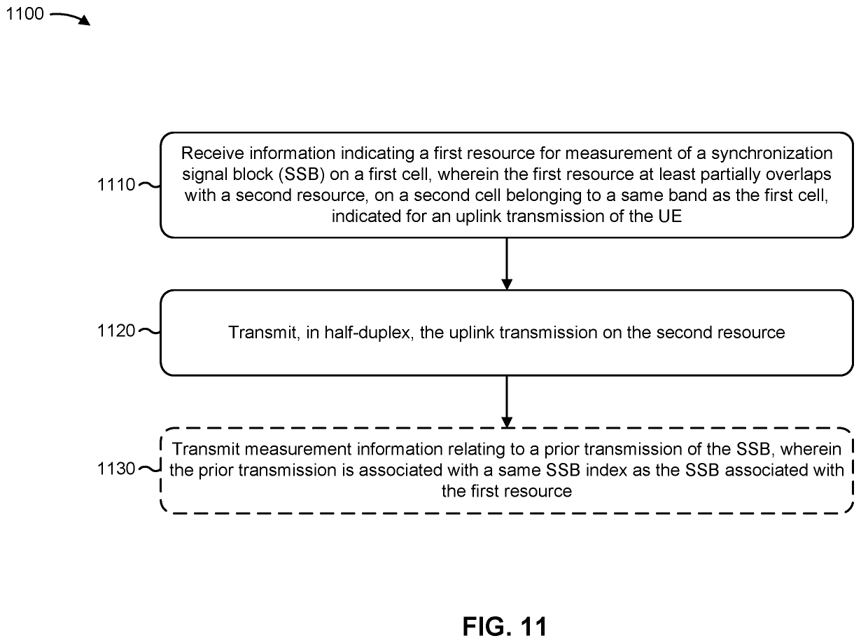

The controller/processor 240 of the network node 110, the controller/processor 280 of the UE 120, and/or any other component(s) of FIG. 2 may perform one or more techniques associated with priority for conflicting transmissions, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting capability information indicating that the UE has a capability for an intra-band conflict resolution rule for resolving a conflict between a first communication on a first semi-statically configured resource of a first cell and a second resource on a second cell based at least in part on a first priority of the first communication; and/or means for performing at least one of the first communication or the second communication according to the intra-band conflict resolution rule. In some aspects, the UE includes means for receiving information indicating a first resource for measurement of a synchronization signal block (SSB) on a first cell, wherein the first resource at least partially overlaps with a second resource, on a second cell belonging to a same band as the first cell, indicated for an uplink transmission of the UE; and/or means for transmitting, in half-duplex, the uplink transmission on the second resource. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

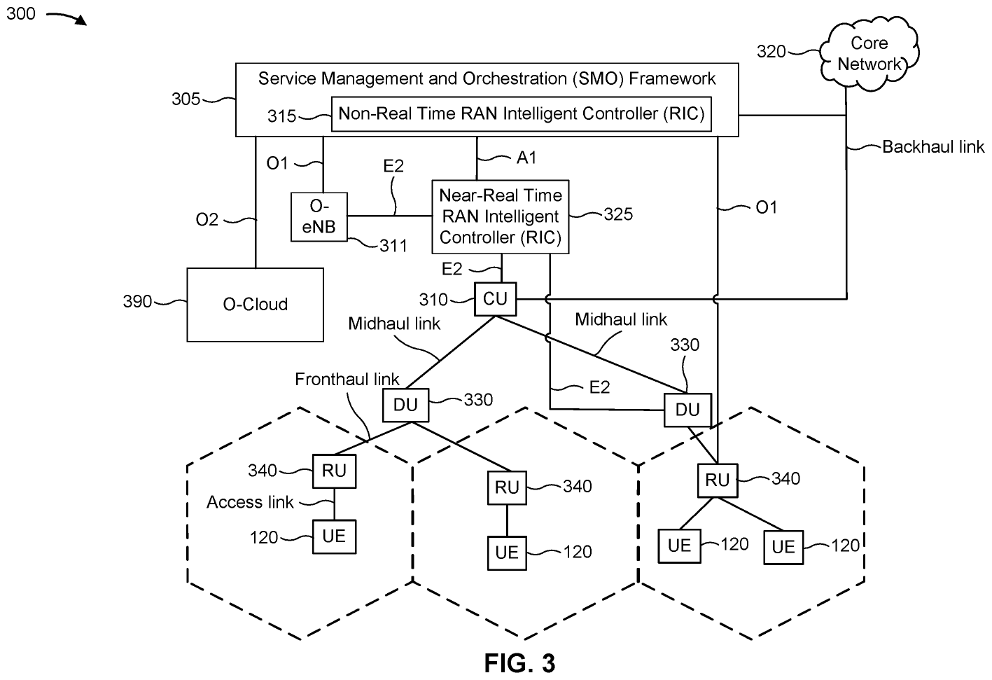

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

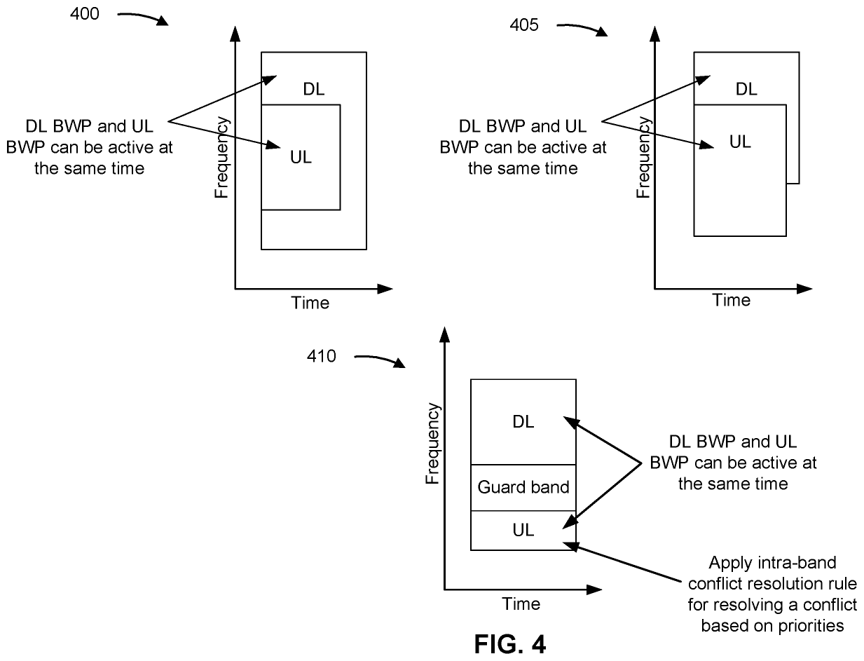

FIG. 4 is a diagram illustrating examples 400, 405, and 410 of full-duplex communication in a wireless network, in accordance with the present disclosure. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 4, examples 400 and 405 show examples of in-band full-duplex (IBFD) communication. In IBFD, a UE may transmit an uplink communication to a network node and receive a downlink communication from the network node on the same time and frequency resources. As shown in example 400, in a first example of IBFD, the time and frequency resources for uplink communication may fully overlap with the time and frequency resources for downlink communication. As shown in example 405, in a second example of IBFD, the time and frequency resources for uplink communication may partially overlap with the time and frequency resources for downlink communication.

As further shown in FIG. 4, example 410 shows an example of sub-band full-duplex (SBFD) communication, which may also be referred to as “sub-band frequency division duplex (SBFDD)” or “flexible duplex.” In SBFD, a UE may transmit an uplink communication to a network node and receive a downlink communication from the network node at the same time, but on different frequency resources. Alternatively, the network node may receive an uplink communication from a first UE on uplink frequency resources and may transmit a downlink communication to a second UE on downlink frequency resources. For example, the different frequency resources may be sub-bands of a frequency band, such as a time division duplexing band. In some examples, the frequency resources used for downlink communication may be separated from the frequency resources used for uplink communication, in the frequency domain, by a guard band.

In some examples, a conflict may arise between a first communication or resource of the SBFD scheme (on a first cell) and a second communication or resource, which may be associated with the SBFD scheme and may be on a second cell. Some techniques described herein provide intra-band conflict resolution according to an intra-band conflict resolution rule for resolving such a conflict based on relative priorities of the first communication or resource and the second communication or resource.

As indicated above, FIG. 4 is provided as an example. Other examples may differ from what is described with respect to FIG. 4.

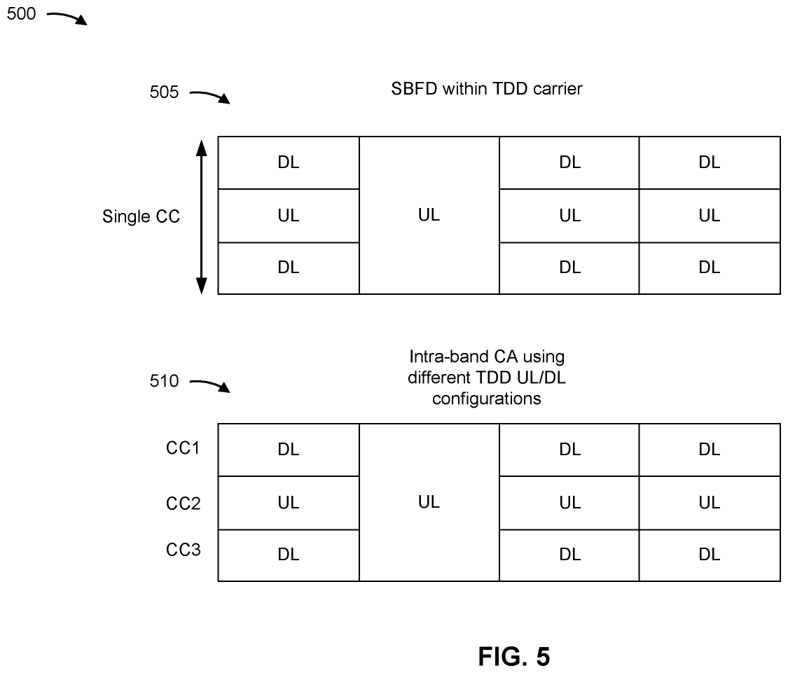

FIG. 5 is a diagram illustrating an example 500 of SBFD schemes, in accordance with the present disclosure. Example 500 illustrates a first SBFD scheme 505 and a second SBFD scheme 510. The first SBFD scheme 505 provides SBFD within a time division duplexing (TDD) carrier, in which a single CC's bandwidth is divided into non-overlapping UL and DL subbands. The second SBFD scheme 510 provides SBFD across multiple carriers (for example, intra-band carrier aggregation (CA)) using different TDD configurations. For example, CC1 and CC3 may have the same TDD configuration (e.g., DUDD, indicating a first slot is a DL slot, a second slot is a UL slot, and a third slot and a fourth slot are DL slots) and CC2 may be configured as an uplink carrier.

A TDD configuration may include a cell-common TDD configuration or a dedicated TDD configuration. A TDD configuration may be semi-statically configured via RRC signaling. A cell-common TDD configuration may be provided via an RRC parameter tdd-UL-DL-ConfigurationCommon, and may apply to all UEs associated with a cell. A dedicated TDD configuration may be provided via an RRC parameter tdd-UL-DL-ConfigurationDedicated and may apply to a UE to which the dedicated TDD configuration is directed. A resource configured for communication in a particular link direction (uplink or downlink) using a TDD configuration is said to be a semi-statically configured resource.

3GPP Release 16 of 5G/NR introduced a directional collision handling rule between a reference cell and another cell for half-duplex operation in TDD CA (with different TDD UL/DL configurations across CCs) associated with the same subcarrier spacing. A subcarrier spacing indicates a size of a subcarrier and a length of a symbol for a carrier. The reference cell is defined as an active cell with the smallest cell index among the configured serving cells of the UE. A serving cell is a cell used for data and/or control communication, and can include a primary cell or a secondary cell. The directional collision handling rule is defined based at least in part on a link direction associated with a first resource on the reference cell, a link direction associated with a second resource on another cell, and how the link direction for the first resource and the second resource are configured. Some scenarios are considered as error cases and not allowed. Some other scenarios are allowed, and the UE may drop transmission or reception on the other cell.

According to the directional collision handling rule, if the reference cell is configured by higher layer (RRC) to receive PDSCH (SPS), PDCCH, or CSI-RS, and if the other cell has a TDD configuration (cell-common or dedicated) indicating conflicting symbols as uplink symbols, the UE may assume that the uplink symbols of the other cell are flexible symbols. According to the directional collision handling rule, if the reference cell is configured by higher layer (RRC) to transmit PUSCH (e.g., CG), PUCCH, SRS, or PRACH, and if the other cell has a TDD configuration (cell-common or dedicated) indicating conflicting symbols as downlink symbols, the UE may assume that the downlink symbols of the other cell are flexible symbols. According to the directional collision handling rule, if the reference cell is configured by higher layer (RRC) to transmit PPUSH (CG), PUCCH, SRS, or PRACH, or has a TDD configuration (cell-common or dedicated) indicating one or more symbols as uplink symbols, and if the other cell has conflicting downlink symbols configured by higher layer (RRC) to receive PDSCH (SPS), PDCCH, or CSI-RS, the UE may drop the conflicting downlink symbols of the other cell. According to the directional collision handling rule, if the reference cell is configured by higher layer (RRC) to receive PDSCH (SPS), PDCCH, or CSI-RS, or has a TDD configuration (cell-common or dedicated) indicating one or more symbols as downlink symbols, and if the other cell has conflicting uplink symbols configured by higher layer (RRC) to transmit PPUSH (CG), PUCCH, SRS, or PRACH, the UE may drop the conflicting uplink symbols of the other cell.

In some cases, the UE assumes a symbol indicated as downlink or uplink by tdd-UL-DL-ConfigurationCommon or tdd-UL-DL-ConfigurationDedicated on another cell to be flexible, if the UE is respectively configured by higher layers to transmit SRS, PUCCH, PUSCH, or PRACH or to receive PDCCH, PDSCH, or CSI-RS on the reference cell. In some aspects, the UE does not receive a PDCCH, PDSCH or CSI-RS that is configured by higher layers on a set of symbols on another cell if at least one symbol from the set of symbols is indicated as uplink by tdd-UL-DL-ConfigurationCommon or tdd-UL-DL-ConfigurationDedicated or is a symbol corresponding to an SRS, PUCCH, PUSCH, or PRACH transmission that is configured by higher layers on the reference cell. In some aspects, the UE does not transmit a PUCCH, PUSCH or PRACH that is configured by higher layers on a set of symbols on another cell if at least one symbol from the set of symbols is indicated as downlink by tdd-UL-DLConfigurationCommon or tdd-UL-DL-ConfigurationDedicated or is a symbol corresponding to a PDCCH, PDSCH, or CSI-RS reception that is configured by higher layers on the reference cell. In some aspects, the UE does not transmit an SRS that is configured by higher layers on a set of symbols on another cell if the set of symbols is indicated as downlink by tdd-UL-DL-ConfigurationCommon or tdd-UL-DL-ConfigurationDedicated or corresponds to a PDCCH, PDSCH or CSI-RS reception that is configured by higher layers on the reference cell

In some legacy systems, when a set of symbols of a slot are indicated for SSB reception in a cell, then the UE does not transmit PUCCH, PUSCH or PRACH in the slot if transmission of the PUCCH, PUSCH, or PRACH overlaps with any symbol of the set of symbols, and the UE does not transmit SRS in the set of symbols.

The directional collision handling rule may lead to inefficient allocation of resources. As one example, when one or more symbols on the reference cell are indicated as UL, then the UE may cancel (e.g., may not receive) DL communications (such as a PDSCH, or CSI-RS configure by higher layer) in other cells, irrespective of whether communications are scheduled on the reference cell. This may waste resources when the network does not schedule any uplink communication on the reference cell. As another example, in some scenarios (e.g., in FR2), when the UE has acquired an SSB using a different beam than a beam on which an SSB is scheduled, there is no need to measure the SSB on the beam on which the SSB is scheduled, so a prohibition against transmitting uplink communications overlapping with a resource in which the SSB is scheduled may lead to inefficient usage of resources. Some techniques described herein provide collision handling rules for a half-duplex UE for SBFD-based intra-band CA (such as based at least in part on priorities). Some techniques described herein provide a relaxed restriction on transmission in a resource overlapping a resource, on a different cell, in which an SSB reception is indicated.

As indicated above, FIG. 5 is provided as an example. Other examples may differ from what is described with regard to FIG. 5.

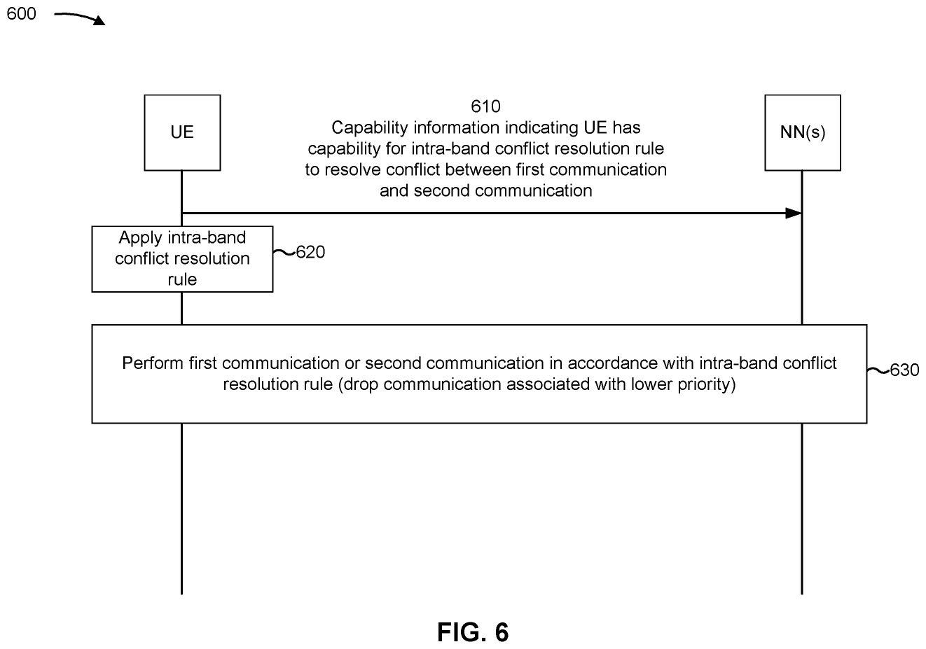

FIG. 6 is a diagram illustrating an example 600 of conflict resolution using an intra-band conflict resolution rule, in accordance with the present disclosure. As shown, example 600 includes a UE (e.g., UE 120) and a network node (e.g., network node 110).

As shown by reference number 610, the UE may transmit, and the network node may obtain (e.g., receive from the UE, receive from another network node), capability information. The capability information may indicate that the UE has a capability for an intra-band conflict resolution rule. The intra-band conflict resolution rule may indicate how to resolve a conflict between a first communication on a first semi-statically configured resource of a first cell, and a second resource on a second cell. For example, the intra-band conflict resolution rule may be based at least in part on a first priority of the first communication on the first semi-statically configured resource. In some aspects, the intra-band conflict resolution rule may be based at least in part on a second priority of the second resource or a second communication on the second resource. That is, the first priority may be a priority of the first communication or of the first semi-statically configured resource, and the second priority may be a priority of the second communication or of the second resource. The first semi-statically configured resource (or the first communication) may have a first link direction, and the second resource (or the second communication) may have a second link direction different than the first link direction. The capability for the intra-band conflict resolution rule may be specific to half-duplex communication (e.g., may be used to resolve conflicts between resources for a half-duplex UE), and the first cell and the second cell may be configured for sub-band full duplex intra-band carrier aggregation, as illustrated in FIG. 5.

The intra-band conflict resolution rule may be based, at least in part, on a reference cell selected from the first cell or the second cell. In some aspects described herein, the first cell is the reference cell. In some other aspects described herein, the second cell is the reference cell.

In some aspects, the first semi-statically configured resource has an uplink configuration (is associated with an uplink direction). For example, the first semi-statically configured resource may be configured, via RRC signaling, for transmission of a physical uplink control channel, a physical uplink shared channel, a sounding reference signal, or a physical random access channel. In some aspects, the first semi-statically configured resource has a downlink configuration (is associated with a downlink direction). For example, the first semi-statically configured resource may be configured, via RRC signaling, for reception of a physical downlink control channel, a physical downlink shared channel, or a channel state information reference signal.

In some aspects, the second resource has an uplink configuration (is associated with an uplink direction). For example, the second resource may be configured, via RRC signaling, for transmission of a physical uplink control channel, a physical uplink shared channel, a sounding reference signal, or a physical random access channel. As another example, the second resource may be configured, via signaling (e.g., RRC signaling or a system information block (SIB) such as SIB1) of a cell-common TDD configuration or a dedicated TDD configuration, for uplink communication. In some aspects, the second resource has a downlink configuration (is associated with a downlink direction). For example, the second resource may be configured, via RRC signaling, for reception of a physical downlink control channel, a physical downlink shared channel, or a channel state information reference signal. As another example, the second resource may be configured, via signaling of a cell-common TDD configuration or a dedicated TDD configuration, for downlink communication.

The first semi-statically configured resource (or the first communication) may be associated with a first priority. The second resource (or the second communication, if applicable) may be associated with a second priority, in some examples. In some aspects, a priority (such as the first priority or the second priority) may be based at least in part on a physical channel priority, such as a physical layer priority of the resource or communication (e.g., higher priority versus lower priority transmission/reception). In some aspects, a priority (such as the first priority or the second priority) may be based at least in part on a logical channel priority of the resource or communication. In some aspects, a priority (such as the first priority or the second priority) may be based at least in part on a quality of service requirement, such as a block error rate (BLER) requirement or a delay budget (e.g., an ultra-reliable low-latency communication (URLLC) delay budget as compared to an enhanced mobile broadband (eMBB) delay budget). In some aspects, a priority (such as the first priority or the second priority) may be based at least in part on a signal type (e.g., a content of the communication or a type of the communication, such as if the communication is a channel state information (CSI) report versus a PDSCH). In some aspects, a priority (such as the first priority or the second priority) may be based at least in part on a channel type (e.g., a control channel versus a data channel). In some aspects, a priority (such as the first priority or the second priority) may be based at least in part on a content of the first communication or the second communication (such as information conveyed in the first communication or the second communication). In some aspects, a priority (such as the first priority or the second priority) may be based at least in part on a time-domain behavior associated with a resource or communication (for example, a semi-persistent communication may be associated with a higher priority than a periodic communication). In some aspects, a priority (such as the first priority or the second priority) may be based at least in part on a time-domain relationship between the first semi-statically configured resource and the second resource (e.g., based on a number of overlapping symbols, where a shorter communication with fewer overlapping symbols is dropped, based on a PUCCH format length, based on which communication starts earlier in time, or based on which communication ends earlier in time). In some aspects, the priority may be determined using a combination of two or more of the above factors.

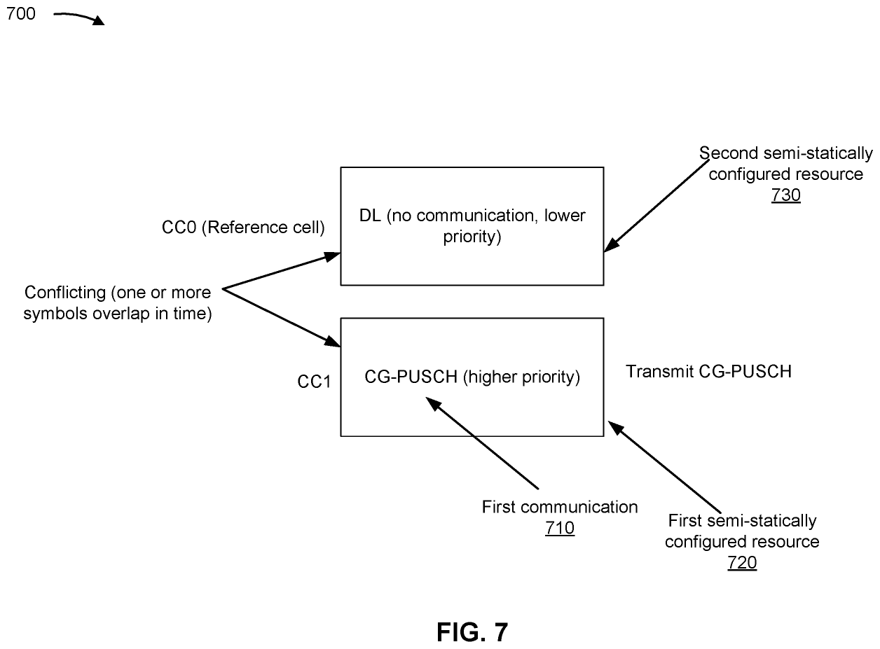

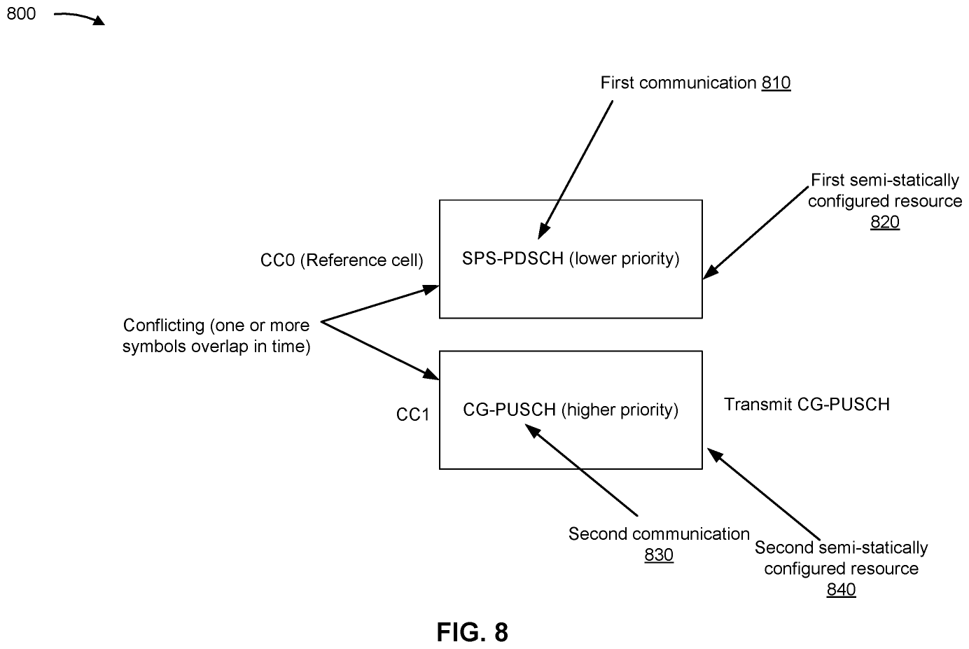

As shown by reference number 620, the UE may apply the intra-band conflict resolution rule. For example, the UE may determine whether or not to drop the first communication. As another example, the UE may determine whether or not to drop the second communication. FIGS. 7 and 8 provide examples of application of the intra-band conflict resolution rule. FIG. 7 is a diagram illustrating an example 700 of applying an intra-band conflict resolution rule, in accordance with the present disclosure. In FIG. 7, the first communication 710 is a CG-PUSCH transmission using the first semi-statically configured resource 720 on CC1 and the second resource 730 is configured as a downlink resource on CC0. One or more symbols of the CG-PUSCH transmission conflict with (e.g., occur in the same time resource as) the second resource 730. The reference cell is CC0. In example 700, the CG-PUSCH may be associated with a priority satisfying a threshold. In some examples, the second resource 730 is associated with no priority. As shown, the UE may transmit the CG-PUSCH. For example, at reference number 630 of FIG. 6, the UE may perform the first communication according to the intra-band conflict resolution rule. In some aspects, the UE may perform the first communication because the first communication is associated with the priority that satisfies the threshold, and because no communication is scheduled on the second resource 730. FIG. 8 is a diagram illustrating an example 800 of applying an intra-band conflict resolution rule, in accordance with the present disclosure. In FIG. 8, the first communication 810 is an SPS-PDSCH reception on a first semi-statically configured resource 820 on CC0 (which is a reference cell) and the second communication 830 is a CG-PUSCH transmission on a second resource 840 on CC1. One or more symbols of the first communication 810 conflict with the second communication 830. In example 800, the CG-PUSCH on CC1 is associated with a higher priority and the SPS-PDSCH on CC0 is associated with a lower priority. In this example, the UE may transmit the CG-PUSCH transmission and drop reception of the SPS-PDSCH. For example, at reference number 630 of FIG. 6, the UE may perform the second communication according to the intra-band conflict resolution rule (e.g., because the second communication is associated with the higher priority).

As indicated above, FIGS. 6-8 are provided as examples. Other examples may differ from what is described with regard to FIGS. 6-8.

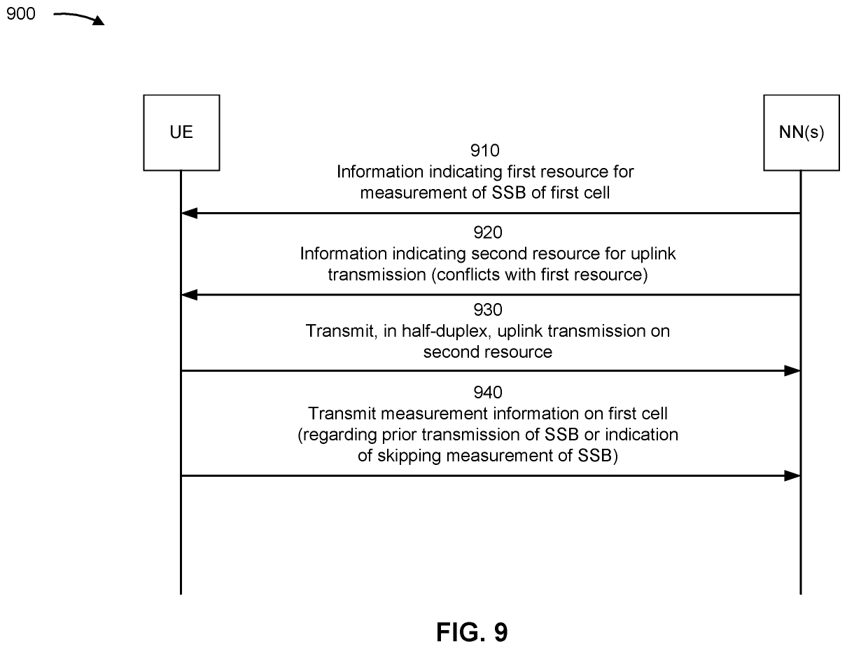

FIG. 9 is a diagram illustrating an example 900 of signaling associated with a relaxed restriction on uplink transmission overlapping with an SSB reception, in accordance with the present disclosure. As shown, example 900 includes a UE (e.g., UE 120) and a network node (e.g., network node 110). The UE may be a half-duplex UE (e.g., communicating in half-duplex).

As shown by reference number 910, the UE may receive, and the network node may output, information indicating a first resource for measurement of an SSB on a first cell. As shown by reference number 920, the UE may receive, and the network node may output, information indicating a second resource for an uplink transmission of the UE. The second resource can be indicated via dynamic signaling (e.g., downlink control information, a dynamic grant), semi-static signaling (e.g., configuration of a CG or a reference signal resource), or the like. The information indicating the first resource may include, for example, system information identifying the first resource and/or an SSB index associated with the SSB to be measured in the first resource. The first resource and the second resource may at least partially overlap each other in time.

As shown by reference number 930, the UE may transmit, in half-duplex, the uplink transmission on the second resource. For example, the UE may transmit the uplink transmission without having measured the SSB on the first cell. In some aspects, the UE may skip measurement of the SSB on the first resource based at least in part on having previously acquired the SSB using a first beam (e.g., in FR2). For example, the first resource may be associated with a second beam different than the first beam. The uplink transmission may be on a dynamic grant resource, or a CG resource (such as a periodic PUCCH (P-PUCCH) transmission carrying a high priority scheduling request or an acknowledgment (ACK)/negative ACK (HACK)). In some aspects, the uplink transmission may include, for example, a PUSCH or a PUSCH.

As shown by reference number 940, the UE may transmit measurement information on the first cell. For example, the measurement information may relate to a measurement of a prior transmission of the SSB (e.g., using the first beam as described above), where the prior transmission is associated with a same SSB index (e.g., SSB number) as the SSB associated with the first resource. As another example, the UE may transmit an indication that indicates (e.g., implicitly) that the UE skipped or did not measure the SSB associated with the first resource.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where the UE (e.g., UE 120) performs operations associated with priority for a half-duplex UE.

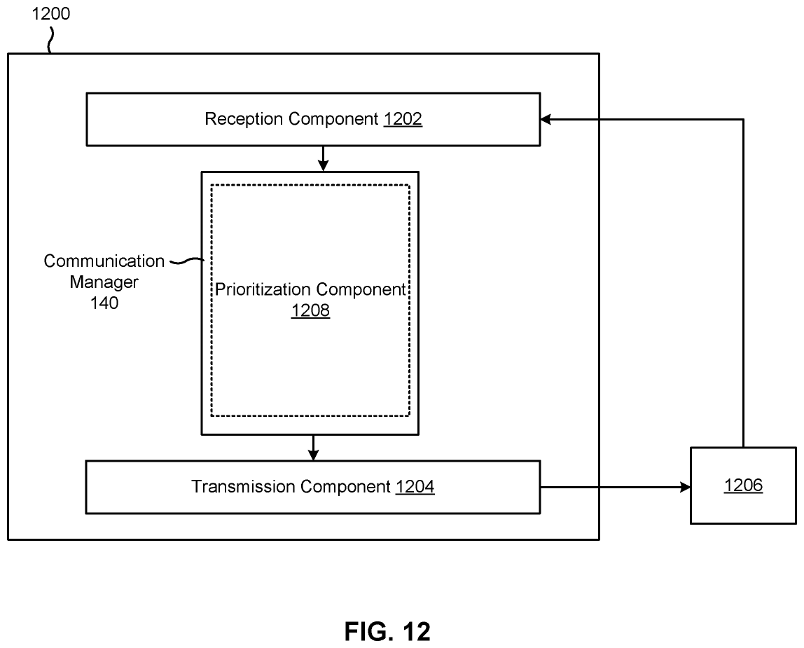

As shown in FIG. 10, in some aspects, process 1000 may include transmitting capability information indicating that the UE has a capability for an intra-band conflict resolution rule for resolving a conflict between one or more symbols of a first communication on a first semi-statically configured resource of a first cell and a second resource on a second cell according to a first priority of the first communication (block 1010). For example, the UE (e.g., using communication manager 140 and/or transmission component 1204, depicted in FIG. 12) may transmit capability information indicating that the UE has a capability for an intra-band conflict resolution rule for resolving a conflict between one or more symbols (e.g., one or more OFDM symbols) of a first communication on a first semi-statically configured resource of a first cell and a second resource on a second cell according to a first priority of the first communication on the first semi-statically configured resource, as described above. In some aspects, the intra-band conflict resolution rule is based at least in part on a second priority of the second resource or a second communication on the second resource.

As further shown in FIG. 10, in some aspects, process 1000 may optionally include dropping a communication, of the first communication or the second communication, associated with a lower priority of the first priority or the second priority (block 1020). For example, the UE (e.g., using communication manager 140 and/or transmission component 1204 or prioritization component 1208, depicted in FIG. 12) may drop a communication, of the first communication or the second communication, associated with a lower priority of the first priority or the second priority.

As further shown in FIG. 10, in some aspects, process 1000 may include performing at least one of the first communication or the second communication according to the intra-band conflict resolution rule (block 1030). For example, the UE (e.g., using communication manager 140 and/or transmission component 1204, depicted in FIG. 12) may perform at least one of the first communication or the second communication according to the intra-band conflict resolution rule, as described above.

Process 1000 may include additional aspects, such as any single aspect or any combination of aspects described below and/or in connection with one or more other processes described elsewhere herein.

In a first aspect, the first semi-statically configured resource has a first link direction and the second resource has a second link direction different than the first link direction.

In a second aspect, alone or in combination with the first aspect, the first semi-statically configured resource comprises at least one of one or more first resources that are configured, via radio resource control (RRC) signaling, for reception of a physical downlink control channel, a physical downlink shared channel, or a channel state information reference signal, or one or more second resources that are configured, via RRC signaling of a cell-common time division duplexing (TDD) configuration or a dedicated TDD configuration, for downlink communication.

In a third aspect, alone or in combination with one or more of the first and second aspects, the first semi-statically configured resource comprises at least one of one or more first resources that are configured, via RRC signaling, for transmission of a physical uplink control channel, a physical uplink shared channel, a sounding reference signal, or a physical random access channel, or one or more second resources that are configured, via RRC signaling of a cell-common TDD configuration or a dedicated TDD configuration, for uplink communication.

In a fourth aspect, alone or in combination with one or more of the first through third aspects, the second resource comprises one or more third resources that are configured, via RRC signaling, for reception of a physical downlink control channel, a physical downlink shared channel, or a channel state information reference signal.

In a fifth aspect, alone or in combination with one or more of the first through fourth aspects, the second cell is a reference cell and the first priority is higher than the second priority based at least in part on no communication being scheduled on the second resource.

In a sixth aspect, alone or in combination with one or more of the first through fifth aspects, the first priority is higher than the second priority based at least in part on no communication being scheduled on the second resource, irrespective of which cell, of the first cell or the second cell, is the reference cell.

In a seventh aspect, alone or in combination with one or more of the first through sixth aspects, the second resource comprises at least one of one or more first resources that are configured, via RRC signaling, for transmission of a physical uplink control channel, a physical uplink shared channel, a sounding reference signal, or a physical random access channel, or one or more second resources that are configured, via RRC signaling of a cell-common TDD configuration or a dedicated TDD configuration, for uplink communication.

In an eighth aspect, alone or in combination with one or more of the first through seventh aspects, the first semi-statically configured resource comprises one or more third resources that are configured, via RRC signaling, for reception of a physical downlink control channel, a physical downlink shared channel, or a channel state information reference signal.

In a ninth aspect, alone or in combination with one or more of the first through eighth aspects, the first cell is a reference cell, the second priority is higher than the first priority, and performing at least one of the first communication or the second communication further comprises transmitting the second communication and dropping the first communication based at least in part on the second priority being higher than the first priority.

In a tenth aspect, alone or in combination with one or more of the first through ninth aspects, the first cell is a reference cell, the second priority is higher than the first priority, the first communication is an uplink communication, the second communication is a downlink communication, and performing at least one of the first communication or the second communication further comprises receiving the second communication and dropping the first communication based at least in part on the second priority being higher than the first priority.

In an eleventh aspect, alone or in combination with one or more of the first through tenth aspects, the second cell is a reference cell, the first priority is higher than the second priority, the first communication is a downlink communication, and performing at least one of the first communication or the second communication further comprises receiving the first communication based at least in part on the first priority being higher than the second priority.

In a twelfth aspect, alone or in combination with one or more of the first through eleventh aspects, at least one of the first priority or the second priority is based at least in part on at least one of a physical channel priority, a logical channel priority, a quality of service requirement, a signal type, a channel type, a content of the first communication or the second communication, a time-domain behavior, or a time-domain relationship between the first semi-statically configured resource and the second resource.

In a thirteenth aspect, alone or in combination with one or more of the first through twelfth aspects, the second cell is a reference cell, and performing at least one of the first communication or the second communication according to the intra-band conflict resolution rule further comprises performing a selected communication, of the first communication or the second communication, associated with a higher priority of the first priority or the second priority.

In a fourteenth aspect, alone or in combination with one or more of the first through thirteenth aspects, the second priority is higher than the first priority based at least in part on no communication being scheduled on the second resource.

In a fifteenth aspect, alone or in combination with one or more of the first through fourteenth aspects, the capability for the intra-band conflict resolution rule is specific to half-duplex communication, and the first cell and the second cell are configured for sub-band full duplex intra-band carrier aggregation.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120) performs operations associated with priority for a half-duplex UE.

As shown in FIG. 11, in some aspects, process 1100 may include receiving information indicating a first resource for measurement of an SSB on a first cell, wherein the first resource at least partially overlaps with a second resource, on a second cell belonging to a same band as the first cell, indicated for an uplink transmission of the UE (block 1110). For example, the UE (e.g., using communication manager 140 and/or reception component 1202, depicted in FIG. 12) may receive information indicating a first resource for measurement of an SSB on a first cell, wherein the first resource at least partially overlaps with a second resource, on a second cell belonging to a same band as the first cell, indicated for an uplink transmission of the UE, as described above.

As further shown in FIG. 11, in some aspects, process 1100 may include transmitting, in half-duplex, the uplink transmission on the second resource (block 1120). For example, the UE (e.g., using communication manager 140 and/or transmission component 1204, depicted in FIG. 12) may transmit, in half-duplex, the uplink transmission on the second resource, as described above.

As further shown in FIG. 11, in some aspects, process 1100 may include transmitting measurement information relating to a prior transmission of the SSB (block 1130). For example, the UE (e.g., using communication manager 140 and/or transmission component 1204, depicted in FIG. 12) may transmit measurement information relating to a prior transmission of the SSB.

Process 1100 may include additional aspects, such as any single aspect or any combination of aspects described below and/or in connection with one or more other processes described elsewhere herein.

In a first aspect, transmitting, in half-duplex, the uplink transmission on the second resource further comprises transmitting the uplink transmission without having measured the SSB in the first cell.

In a second aspect, alone or in combination with the first aspect, process 1100 includes skipping measurement of the SSB on the first resource based at least in part on having previously acquired the SSB using a first beam, wherein the first resource is associated with a second beam different than the first beam.

In a third aspect, alone or in combination with one or more of the first and second aspects, process 1100 includes transmitting an indication that the UE has not measured the SSB on the first cell.

In a fourth aspect, alone or in combination with one or more of the first through third aspects, process 1100 includes transmitting measurement information relating to a prior transmission of the SSB, wherein the prior transmission is associated with a same SSB index as the SSB associated with the first resource.

In a fifth aspect, alone or in combination with one or more of the first through fourth aspects, the uplink transmission is associated with a dynamic grant.

In a sixth aspect, alone or in combination with one or more of the first through fifth aspects, the uplink transmission is associated with a configured grant.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include a prioritization component 1208, among other examples.

In some aspects, the apparatus 1200 may be configured to perform one or more operations described herein in connection with FIGS. 4-9. Additionally, or alternatively, the apparatus 1200 may be configured to perform one or more processes described herein, such as process 1000 of FIG. 10, process 1100 of FIG. 11, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The transmission component 1204 may transmit capability information indicating that the UE has a capability for an intra-band conflict resolution rule for resolving a conflict between a first communication on a first semi-statically configured resource of a first cell and a second resource on a second cell according to a first priority of the first communication on the first semi-statically configured resource. The transmission component 1204 or the prioritization component 1208 may perform at least one of the first communication or the second communication according to the intra-band conflict resolution rule.

The reception component 1202 may receive information indicating a first resource for measurement of an SSB on a first cell, wherein the first resource at least partially overlaps with a second resource, on a second cell belonging to a same band as the first cell, indicated for an uplink transmission of the UE. The transmission component 1204 may transmit, in half-duplex, the uplink transmission on the second resource.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

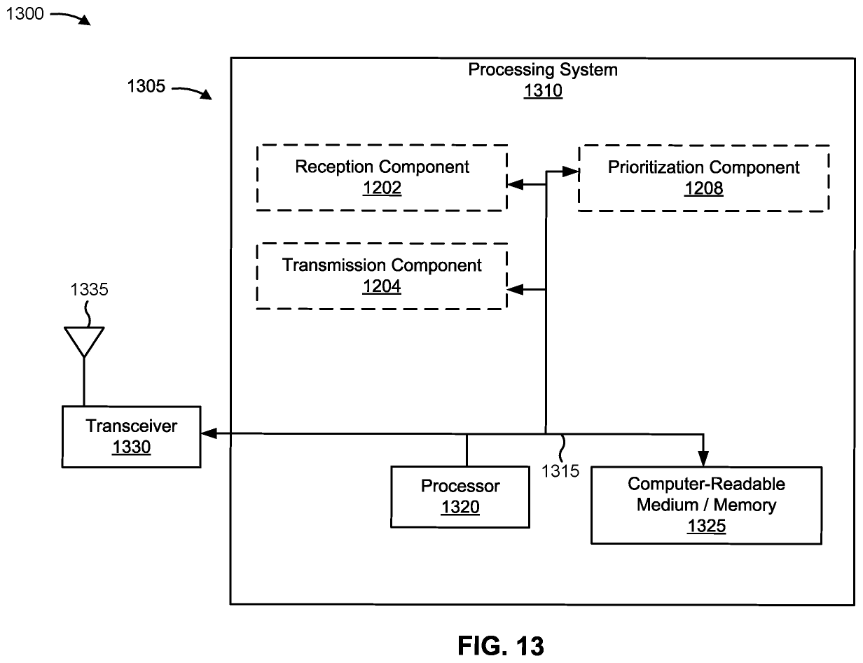

FIG. 13 is a diagram illustrating an example 1300 of a hardware implementation for an apparatus 1305 employing a processing system 1310, in accordance with the present disclosure. The apparatus 1305 may be a UE.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors and/or hardware components, represented by the processor 1320, the illustrated components, and the computer-readable medium/memory 1325. The bus 1315 may also link various other circuits, such as timing sources, peripherals, voltage regulators, and/or power management circuits.

The processing system 1310 may be coupled to a transceiver 1330. The transceiver 1330 is coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information.

The processing system 1310 includes a processor 1320 coupled to a computer-readable medium/memory 1325. The processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer readable medium/memory 1325, one or more hardware modules coupled to the processor 1320, or some combination thereof.

In some aspects, the processing system 1310 may be a component of the UE 120 and may include the memory 282 and/or at least one of the TX MIMO processor 266, the RX processor 258, and/or the controller/processor 280. In some aspects, the apparatus 1305 for wireless communication includes means for transmitting capability information indicating that the UE has a capability for an intra-band conflict resolution rule for resolving a conflict between a first communication on a first semi-statically configured resource of a first cell and a second resource on a second cell according to a first priority of the first communication on the first semi-statically configured resource; means for performing at least one of the first communication or the second communication according to the intra-band conflict resolution rule; means for receiving information indicating a first resource for measurement of an SSB on a first cell, wherein the first resource at least partially overlaps with a second resource, on a second cell belonging to a same band as the first cell, indicated for an uplink transmission of the UE; and/or means for transmitting, in half-duplex, the uplink transmission on the second resource. The aforementioned means may be one or more of the aforementioned components of the apparatus 1200 and/or the processing system 1310 of the apparatus 1305 configured to perform the functions recited by the aforementioned means. As described elsewhere herein, the processing system 1310 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 13 is provided as an example. Other examples may differ from what is described in connection with FIG. 13.

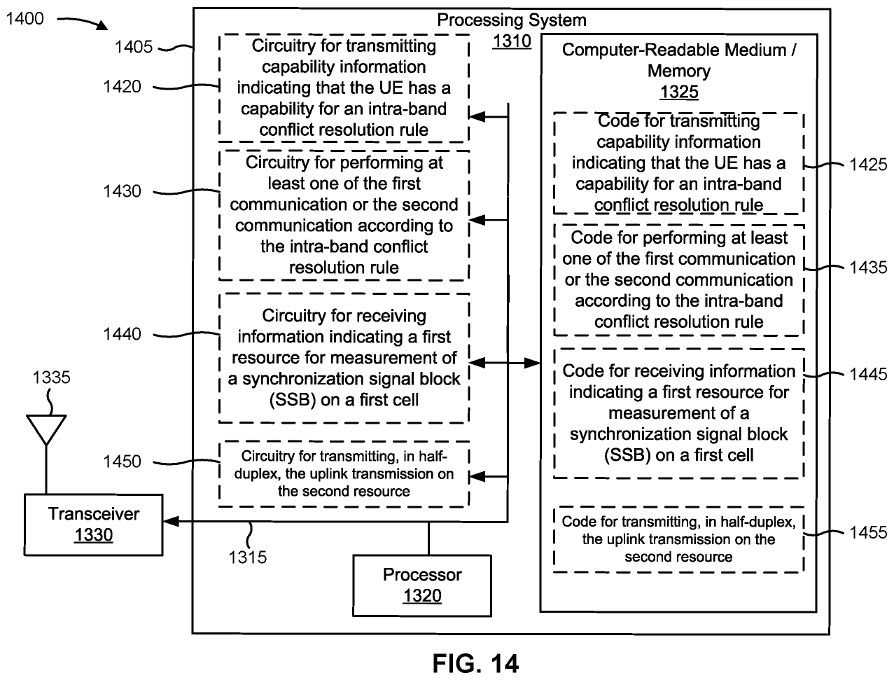

FIG. 14 is a diagram illustrating an example 1400 of an implementation of code and circuitry for an apparatus 1405, in accordance with the present disclosure. The apparatus 1405 may be a UE, or a UE may include the apparatus 1405.

As shown in FIG. 14, the apparatus 1405 may include circuitry for transmitting capability information indicating that the UE has a capability for an intra-band conflict resolution rule for resolving a conflict between a first communication on a first semi-statically configured resource of a first cell and a second resource on a second cell according to a first priority of the first communication on the first semi-statically configured resource (circuitry 1420). For example, the circuitry 1420 may enable the apparatus 1405 to transmit capability information indicating that the UE has a capability for an intra-band conflict resolution rule for resolving a conflict between a first communication on a first semi-statically configured resource of a first cell and a second resource on a second cell according to a first priority of the first communication on the first semi-statically configured resource.

As shown in FIG. 14, the apparatus 1405 may include, stored in computer-readable medium 1325, code for transmitting capability information indicating that the UE has a capability for an intra-band conflict resolution rule for resolving a conflict between a first communication on a first semi-statically configured resource of a first cell and a second resource on a second cell according to a first priority of the first communication on the first semi-statically configured resource (code 1425). For example, the code 1425, when executed by processor 1320, may cause processor 1320 to cause transceiver 1330 to transmit capability information indicating that the UE has a capability for an intra-band conflict resolution rule for resolving a conflict between a first communication on a first semi-statically configured resource of a first cell and a second resource on a second cell according to a first priority of the first communication on the first semi-statically configured resource.

As shown in FIG. 14, the apparatus 1405 may include circuitry for performing at least one of the first communication or the second communication according to the intra-band conflict resolution rule (circuitry 1430). For example, the circuitry 1430 may enable the apparatus 1405 to perform at least one of the first communication or the second communication according to the intra-band conflict resolution rule.

As shown in FIG. 14, the apparatus 1405 may include, stored in computer-readable medium 1325, code for performing at least one of the first communication or the second communication according to the intra-band conflict resolution rule (code 1435). For example, the code 1435, when executed by processor 1320, may cause processor 1320 to cause transceiver 1330 to perform at least one of the first communication or the second communication according to the intra-band conflict resolution rule.

As shown in FIG. 14, the apparatus 1405 may include circuitry for receiving information indicating a first resource for measurement of an SSB on a first cell, wherein the first resource at least partially overlaps with a second resource, on a second cell belonging to a same band as the first cell, indicated for an uplink transmission of the UE (circuitry 1440). For example, the circuitry 1420 may enable the apparatus 1405 to receive information indicating a first resource for measurement of an SSB on a first cell, wherein the first resource at least partially overlaps with a second resource, on a second cell belonging to a same band as the first cell, indicated for an uplink transmission of the UE.

As shown in FIG. 14, the apparatus 1405 may include, stored in computer-readable medium 1325, code for receiving information indicating a first resource for measurement of an SSB on a first cell, wherein the first resource at least partially overlaps with a second resource, on a second cell belonging to a same band as the first cell, indicated for an uplink transmission of the UE (code 1445). For example, the code 1445, when executed by processor 1320, may cause processor 1320 to cause transceiver 1330 to receive information indicating a first resource for measurement of an SSB on a first cell, wherein the first resource at least partially overlaps with a second resource, on a second cell belonging to a same band as the first cell, indicated for an uplink transmission of the UE.

As shown in FIG. 14, the apparatus 1405 may include circuitry for transmitting, in half-duplex, the uplink transmission on the second resource (circuitry 1450). For example, the circuitry 1450 may enable the apparatus 1405 to transmit, in half-duplex, the uplink transmission on the second resource.

As shown in FIG. 14, the apparatus 1405 may include, stored in computer-readable medium 1325, code for transmitting, in half-duplex, the uplink transmission on the second resource (code 1455). For example, the code 1455, when executed by processor 1320, may cause processor 1320 to cause transceiver 1330 to transmit, in half-duplex, the uplink transmission on the second resource.

FIG. 14 is provided as an example. Other examples may differ from what is described in connection with FIG. 14.

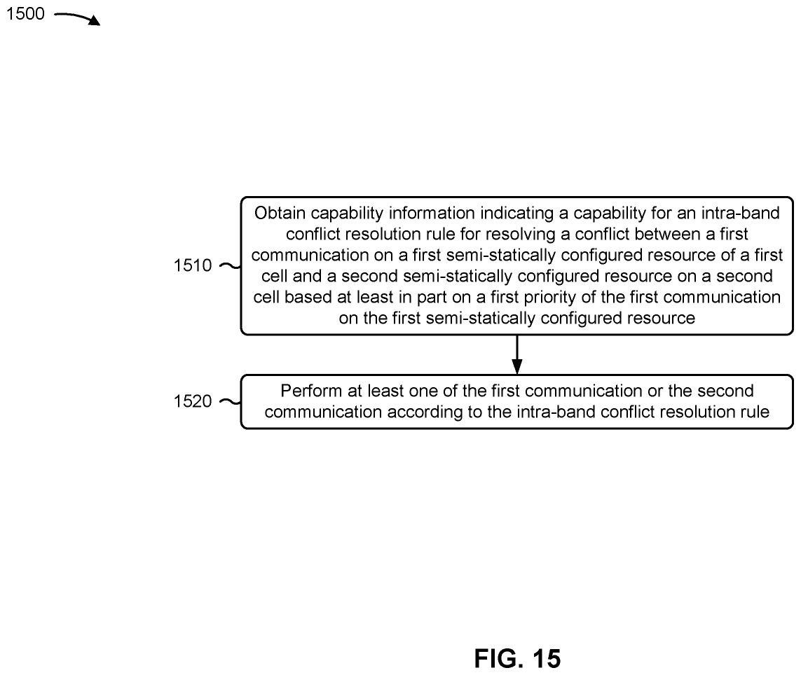

FIG. 15 is a diagram illustrating an example process 1500 performed, for example, by a network node, in accordance with the present disclosure. Example process 1500 is an example where the network node (e.g., network node 110) performs operations associated with priority for a half-duplex UE.

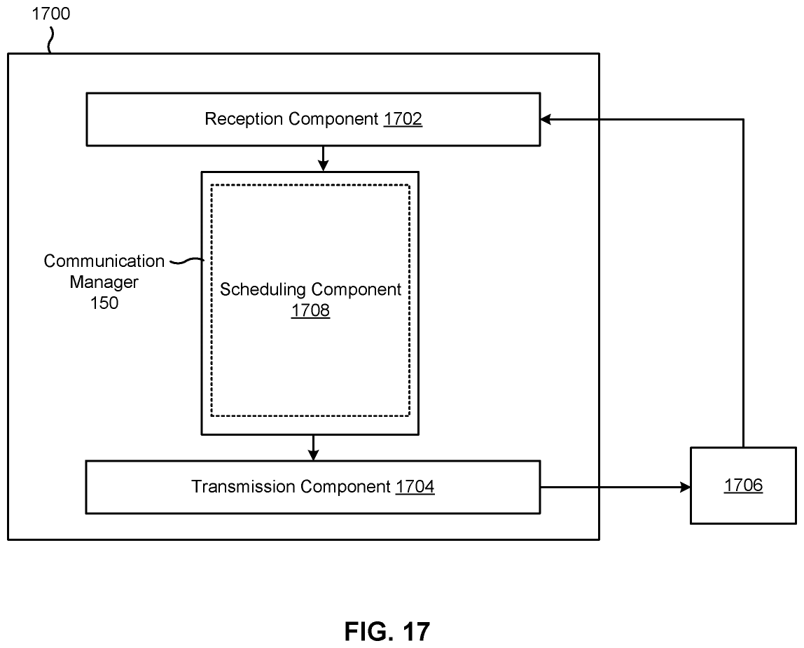

As shown in FIG. 15, in some aspects, process 1500 may include obtaining capability information indicating a capability for an intra-band conflict resolution rule for resolving a conflict between a first communication on a first semi-statically configured resource of a first cell and a second resource on a second cell according to a first priority of the first communication on the first semi-statically configured resource and a second priority of the second resource or a second communication on the second resource (block 1510). For example, the network node (e.g., using communication manager 150 and/or reception component 1702, depicted in FIG. 17) may obtain capability information indicating a capability for an intra-band conflict resolution rule for resolving a conflict between a first communication on a first semi-statically configured resource of a first cell and a second resource on a second cell according to a first priority of the first communication on the first semi-statically configured resource and a second priority of the second resource or a second communication on the second resource, as described above.

As further shown in FIG. 15, in some aspects, process 1500 may include performing at least one of the first communication or the second communication according to the intra-band conflict resolution rule (block 1520). For example, the network node (e.g., using communication manager 150 and/or reception component 1702, depicted in FIG. 17) may perform at least one of the first communication or the second communication according to the intra-band conflict resolution rule, as described above.

Process 1500 may include additional aspects, such as any single aspect or any combination of aspects described below and/or in connection with one or more other processes described elsewhere herein.

In a first aspect, the first semi-statically configured resource has a first link direction and the second resource has a second link direction different than the first link direction.

In a second aspect, alone or in combination with the first aspect, the first semi-statically configured resource comprises at least one of one or more first resources that are configured, via RRC signaling, for reception of a physical downlink control channel, a physical downlink shared channel, or a channel state information reference signal, or one or more second resources that are configured, via RRC signaling of a cell-common TDD configuration or a dedicated TDD configuration, for downlink communication.

In a third aspect, alone or in combination with one or more of the first and second aspects, the first semi-statically configured resource comprises at least one of one or more first resources that are configured, via RRC signaling, for transmission of a physical uplink control channel, a physical uplink shared channel, a sounding reference signal, or a physical random access channel, or one or more second resources that are configured, via RRC signaling of a cell-common TDD configuration or a dedicated TDD configuration, for uplink communication.

In a fourth aspect, alone or in combination with one or more of the first through third aspects, the second resource comprises one or more third resources that are configured, via RRC signaling, for reception of a physical downlink control channel, a physical downlink shared channel, or a channel state information reference signal.

In a fifth aspect, alone or in combination with one or more of the first through fourth aspects, the second cell is a reference cell and the first priority is higher than the second priority based at least in part on no communication being scheduled on the second resource.

In a sixth aspect, alone or in combination with one or more of the first through fifth aspects, the first priority is higher than the second priority based at least in part on no communication being scheduled on the second resource, irrespective of which cell, of the first cell or the second cell, is the reference cell.

In a seventh aspect, alone or in combination with one or more of the first through sixth aspects, the second resource comprises at least one of one or more first resources that are configured, via RRC signaling, for transmission of a physical uplink control channel, a physical uplink shared channel, a sounding reference signal, or a physical random access channel, or one or more second resources that are configured, via RRC signaling of a cell-common TDD configuration or a dedicated TDD configuration, for uplink communication.

In an eighth aspect, alone or in combination with one or more of the first through seventh aspects, the first semi-statically configured resource comprises one or more third resources that are configured, via RRC signaling, for reception of a physical downlink control channel, a physical downlink shared channel, or a channel state information reference signal.

In a ninth aspect, alone or in combination with one or more of the first through eighth aspects, the first cell is a reference cell, the second priority is higher than the first priority, and performing at least one of the first communication or the second communication further comprises obtaining the second communication and dropping the first communication based at least in part on the second priority being higher than the first priority.

In a tenth aspect, alone or in combination with one or more of the first through ninth aspects, the first cell is a reference cell, the second priority is higher than the first priority, the first communication is an uplink communication, the second communication is a downlink communication, and performing at least one of the first communication or the second communication further comprises outputting the second communication and dropping the first communication based at least in part on the second priority being higher than the first priority.

In an eleventh aspect, alone or in combination with one or more of the first through tenth aspects, the second cell is a reference cell, the first priority is higher than the second priority, the first communication is a downlink communication, and performing at least one of the first communication or the second communication further comprises obtaining the first communication based at least in part on the first priority being higher than the second priority.

In a twelfth aspect, alone or in combination with one or more of the first through eleventh aspects, at least one of the first priority or the second priority is based at least in part on at least one of a physical channel priority, a logical channel priority, a quality of service requirement, a signal type, a channel type, a content of the first communication or the second communication, a time-domain behavior, or a time-domain relationship between the first semi-statically configured resource and the second resource.

In a thirteenth aspect, alone or in combination with one or more of the first through twelfth aspects, the second cell is a reference cell, and wherein performing at least one of the first communication or the second communication according to the intra-band conflict resolution rule further comprises performing a selected communication, of the first communication or the second communication, associated with a higher priority of the first priority or the second priority.

In a fourteenth aspect, alone or in combination with one or more of the first through thirteenth aspects, the second priority is higher than the first priority based at least in part on no communication being scheduled on the second resource.

In a fifteenth aspect, alone or in combination with one or more of the first through fourteenth aspects, process 1500 includes dropping a communication, of the first communication or the second communication, associated with a lower priority of the first priority or the second priority.

In a sixteenth aspect, alone or in combination with one or more of the first through fifteenth aspects, the capability for the intra-band conflict resolution rule is specific to half-duplex communication, and wherein the first cell and the second cell are configured for sub-band full duplex intra-band carrier aggregation.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

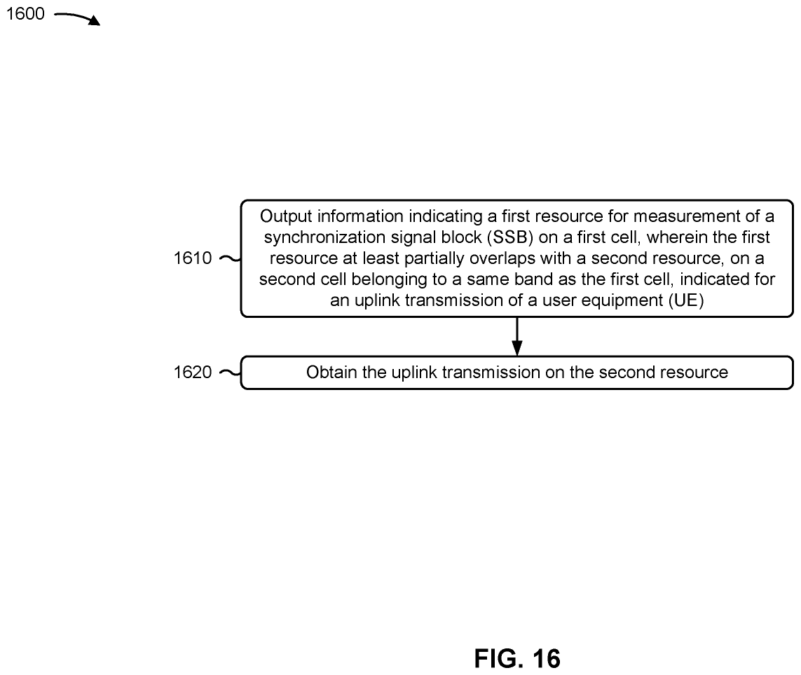

FIG. 16 is a diagram illustrating an example process 1600 performed, for example, by a network node, in accordance with the present disclosure. Example process 1600 is an example where the network node (e.g., network node 110) performs operations associated with priority for a half-duplex user equipment.

As shown in FIG. 16, in some aspects, process 1600 may include outputting information indicating a first resource for measurement of a SSB on a first cell, wherein the first resource at least partially overlaps with a second resource, on a second cell belonging to a same band as the first cell, indicated for an uplink transmission of a UE (block 1610). For example, the network node (e.g., using communication manager 150 and/or transmission component 1704, depicted in FIG. 17) may output information indicating a first resource for measurement of an SSB on a first cell, wherein the first resource at least partially overlaps with a second resource, on a second cell belonging to a same band as the first cell, indicated for an uplink transmission of a UE, as described above.

As further shown in FIG. 16, in some aspects, process 1600 may include obtaining the uplink transmission on the second resource (block 1620). For example, the network node (e.g., using communication manager 150 and/or reception component 1702, depicted in FIG. 17) may obtain the uplink transmission on the second resource, as described above.

Process 1600 may include additional aspects, such as any single aspect or any combination of aspects described below and/or in connection with one or more other processes described elsewhere herein.

In a first aspect, process 1600 includes obtaining an indication that the UE has not measured the SSB on the first cell.

In a second aspect, alone or in combination with the first aspect, process 1600 includes obtaining measurement information relating to a prior transmission of the SSB, wherein the prior transmission is associated with a same SSB index as the SSB associated with the first resource.

In a third aspect, alone or in combination with one or more of the first and second aspects, the uplink transmission is associated with a dynamic grant.

In a fourth aspect, alone or in combination with one or more of the first through third aspects, the uplink transmission is associated with a configured grant.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram of an example apparatus 1700 for wireless communication, in accordance with the present disclosure. The apparatus 1700 may be a network node, or a network node may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704. As further shown, the apparatus 1700 may include the communication manager 150. The communication manager 150 may include a scheduling component 1708, among other examples.

In some aspects, the apparatus 1700 may be configured to perform one or more operations described herein in connection with FIGS. 4-9. Additionally, or alternatively, the apparatus 1700 may be configured to perform one or more processes described herein, such as process 1500 of FIG. 15, process 1600 of FIG. 16, or a combination thereof. In some aspects, the apparatus 1700 and/or one or more components shown in FIG. 17 may include one or more components of the network node described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the network node described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the network node described in connection with FIG. 2. In some aspects, the transmission component 1704 may be co-located with the reception component 1702 in a transceiver.

In some aspects, the transmission component 1704 may transmit capability information indicating that the UE has a capability for an intra-band conflict resolution rule for resolving a conflict between a first communication on a first semi-statically configured resource of a first cell and a second resource on a second cell according to a first priority of the first communication on the first semi-statically configured resource and a second priority of the second resource or a second communication on the second resource. The transmission component 1704 or the reception component 1702 may perform at least one of the first communication or the second communication according to the intra-band conflict resolution rule. The scheduling component 1708 may schedule the first communication and/or the second communication.

The reception component 1702 may obtain capability information indicating a capability for an intra-band conflict resolution rule for resolving a conflict between a first communication on a first semi-statically configured resource of a first cell and a second resource on a second cell according to a first priority of the first communication on the first semi-statically configured resource and a second priority of the second resource or a second communication on the second resource. The transmission component 1704 or the reception component 1702 may perform at least one of the first communication or the second communication according to the intra-band conflict resolution rule. The scheduling component 1708 may schedule the first communication and/or the second communication.

The transmission component 1704 may output information indicating a first resource for measurement of an SSB on a first cell, wherein the first resource at least partially overlaps with a second resource, on a second cell belonging to a same band as the first cell, indicated for an uplink transmission of a UE. The reception component 1702 may obtain the uplink transmission on the second resource.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

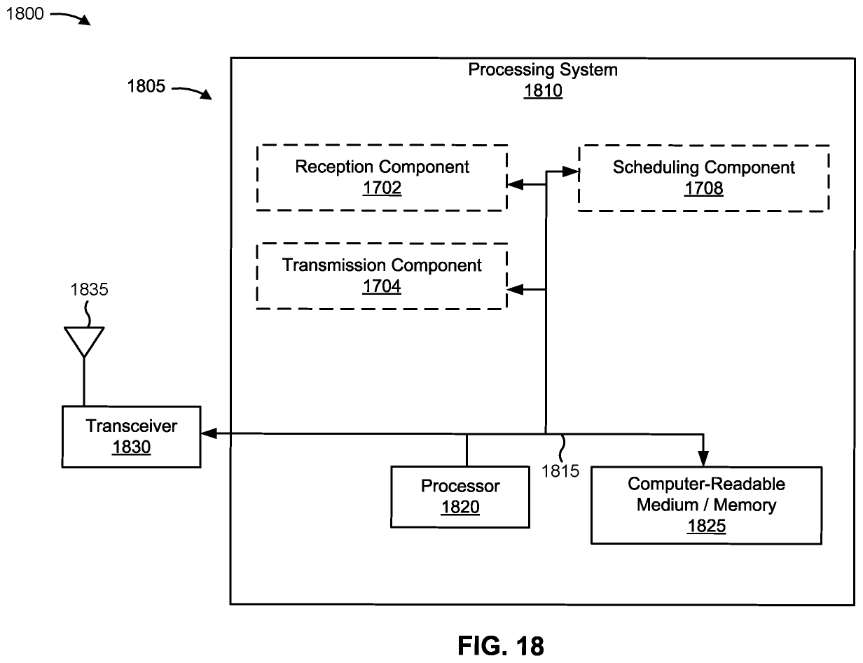

FIG. 18 is a diagram illustrating an example 1800 of a hardware implementation for an apparatus 1805 employing a processing system 1810, in accordance with the present disclosure. The apparatus 1805 may be a network node.

The processing system 1810 may be implemented with a bus architecture, represented generally by the bus 1815. The bus 1815 may include any number of interconnecting buses and bridges depending on the specific application of the processing system 1810 and the overall design constraints. The bus 1815 links together various circuits including one or more processors and/or hardware components, represented by the processor 1820, the illustrated components, and the computer-readable medium/memory 1825. The bus 1815 may also link various other circuits, such as timing sources, peripherals, voltage regulators, and/or power management circuits.

The processing system 1810 may be coupled to a transceiver 1830. The transceiver 1830 is coupled to one or more antennas 1835. The transceiver 1830 provides a means for communicating with various other apparatuses over a transmission medium. The transceiver 1830 receives a signal from the one or more antennas 1835, extracts information from the received signal, and provides the extracted information to the processing system 1810, specifically the reception component 1702. In addition, the transceiver 1830 receives information from the processing system 1810, specifically the transmission component 1704, and generates a signal to be applied to the one or more antennas 1835 based at least in part on the received information.

The processing system 1810 includes a processor 1820 coupled to a computer-readable medium/memory 1825. The processor 1820 is responsible for general processing, including the execution of software stored on the computer-readable medium/memory 1825. The software, when executed by the processor 1820, causes the processing system 1810 to perform the various functions described herein for any particular apparatus. The computer-readable medium/memory 1825 may also be used for storing data that is manipulated by the processor 1820 when executing software. The processing system further includes at least one of the illustrated components. The components may be software modules running in the processor 1820, resident/stored in the computer readable medium/memory 1825, one or more hardware modules coupled to the processor 1820, or some combination thereof.

In some aspects, the processing system 1810 may be a component of the base station 110 and may include the memory 242 and/or at least one of the TX MIMO processor 230, the RX processor 238, and/or the controller/processor 240. In some aspects, the apparatus 1805 for wireless communication includes means for obtaining capability information indicating a capability for an intra-band conflict resolution rule for resolving a conflict between a first communication on a first semi-statically configured resource of a first cell and a second resource on a second cell according to a first priority of the first communication on the first semi-statically configured resource and a second priority of the second resource or a second communication on the second resource; means for performing at least one of the first communication or the second communication according to the intra-band conflict resolution rule; means for outputting information indicating a first resource for measurement of a synchronization signal block (SSB) on a first cell, wherein the first resource at least partially overlaps with a second resource, on a second cell belonging to a same band as the first cell, indicated for an uplink transmission of a user equipment (UE); and means for obtaining the uplink transmission on the second resource. The aforementioned means may be one or more of the aforementioned components of the apparatus 1700 and/or the processing system 1810 of the apparatus 1805 configured to perform the functions recited by the aforementioned means. As described elsewhere herein, the processing system 1810 may include the TX MIMO processor 230, the receive processor 238, and/or the controller/processor 240. In one configuration, the aforementioned means may be the TX MIMO processor 230, the receive processor 238, and/or the controller/processor 240 configured to perform the functions and/or operations recited herein.

FIG. 18 is provided as an example. Other examples may differ from what is described in connection with FIG. 18.

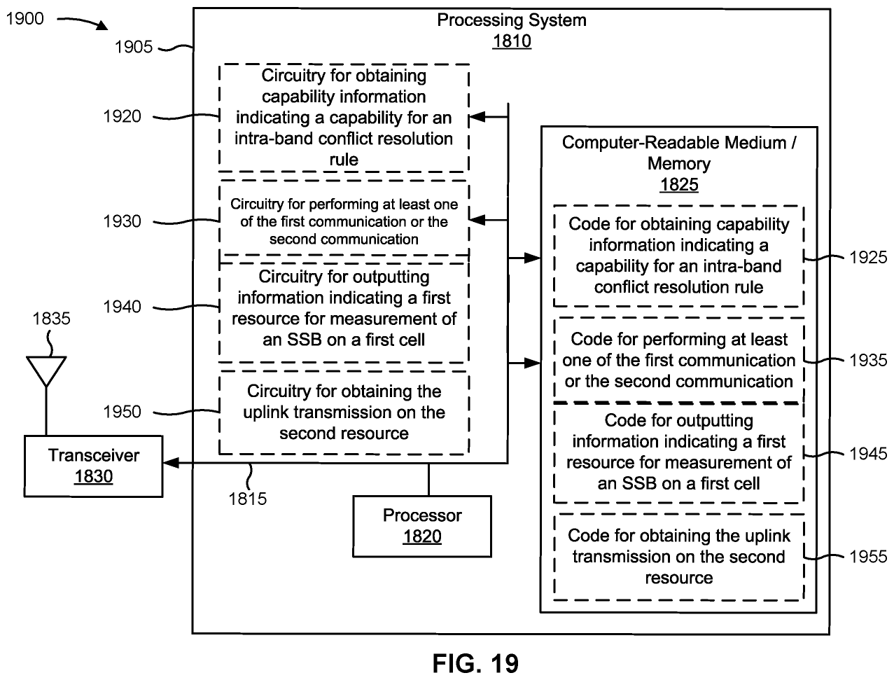

FIG. 19 is a diagram illustrating an example 1900 of an implementation of code and circuitry for an apparatus 1905, in accordance with the present disclosure. The apparatus 1905 may be a network node, or a network node may include the apparatus 1905.

As shown in FIG. 19, the apparatus 1905 may include circuitry for obtaining capability information indicating a capability for an intra-band conflict resolution rule (circuitry 1920). For example, the circuitry 1920 may enable the apparatus 1905 to obtain capability information indicating a capability for an intra-band conflict resolution rule.

As shown in FIG. 19, the apparatus 1905 may include, stored in computer-readable medium 1825, code for obtaining capability information indicating a capability for an intra-band conflict resolution rule (code 1925). For example, the code 1925, when executed by processor 1820, may cause processor 1820 to cause transceiver 1830 to obtain capability information indicating a capability for an intra-band conflict resolution rule.

As shown in FIG. 19, the apparatus 1905 may include circuitry for performing at least one of the first communication or the second communication according to the intra-band conflict resolution rule (circuitry 1930). For example, the circuitry 1930 may enable the apparatus 1905 to perform at least one of the first communication or the second communication according to the intra-band conflict resolution rule.

As shown in FIG. 19, the apparatus 1905 may include, stored in computer-readable medium 1825, code for performing at least one of the first communication or the second communication according to the intra-band conflict resolution rule (code 1935). For example, the code 1935, when executed by processor 1820, may cause processor 1820 to cause transceiver 1830 to perform at least one of the first communication or the second communication according to the intra-band conflict resolution rule.

As shown in FIG. 19, the apparatus 1905 may include circuitry for outputting information indicating a first resource for measurement of a synchronization signal block (SSB) on a first cell (circuitry 1940). For example, the circuitry 1940 may enable the apparatus 1905 to output information indicating a first resource for measurement of a SSB on a first cell, wherein the first resource at least partially overlaps with a second resource, on a second cell belonging to a same band as the first cell, indicated for an uplink transmission of a UE.

As shown in FIG. 19, the apparatus 1905 may include, stored in computer-readable medium 1825, code for outputting information indicating a first resource for measurement of a SSB on a first cell (code 1945). For example, the code 1945, when executed by processor 1820, may cause processor 1820 to cause transceiver 1830 to output information indicating a first resource for measurement of a SSB on a first cell.

As shown in FIG. 19, the apparatus 1905 may include circuitry for obtaining the uplink transmission on the second resource (circuitry 1950). For example, the circuitry 1930 may enable the apparatus 1905 to obtain the uplink transmission on the second resource.

As shown in FIG. 19, the apparatus 1905 may include, stored in computer-readable medium 1825, code for obtaining the uplink transmission on the second resource (code 1955). For example, the code 1955, when executed by processor 1820, may cause processor 1820 to cause transceiver 1830 to obtain the uplink transmission on the second resource.

FIG. 19 is provided as an example. Other examples may differ from what is described in connection with FIG. 19.

The following provides an overview of some Aspects of the present disclosure:

Aspect 1: A method of wireless communication performed by a user equipment (UE), comprising: transmitting capability information indicating that the UE has a capability for an intra-band conflict resolution rule for resolving a conflict, in at least one symbol, between a first communication on a first semi-statically configured resource of a first cell and a second resource on a second cell based at least in part on a first priority of the first communication, the first semi-statically configured resource having a first link direction and the second resource having a second link direction different than the first link direction; and performing at least one of the first communication or a second communication on the second resource according to the intra-band conflict resolution rule.

Aspect 2: The method of Aspect 1, wherein the second resource is semi-statically configured for transmission or reception of at least one of: a physical uplink control channel, a physical uplink shared channel, a sounding reference signal, a physical random access channel, a physical downlink control channel, a physical downlink shared channel, or a channel state information reference signal.

Aspect 3: The method of any of Aspects 1-2, wherein the second resource is configured, by a cell-common time division duplexing (TDD) configuration or a dedicated TDD configuration, for the second link direction.

Aspect 4: The method of any of Aspects 1-3, wherein performing at least one of the first communication or the second communication on the second resource according to the intra-band conflict resolution rule further comprises performing at least one of the first communication or the second communication based at least in part on a second priority associated with the second communication or the second resource.

Aspect 5: The method of Aspect 4, wherein the first cell is a reference cell, the second priority is higher than the first priority, and performing at least one of the first communication or the second communication further comprises transmitting the second communication and dropping the first communication based at least in part on the second priority being higher than the first priority.

Aspect 6: The method of Aspect 5, wherein the second resource is semi-statically configured for transmission or reception of a channel or signal.

Aspect 7: The method of Aspect 5, wherein at least one of the first priority or the second priority is based at least in part on at least one of: a physical channel priority, a logical channel priority, a quality of service requirement, a signal type, a channel type, a content of the first communication or the second communication, a time-domain behavior, or a time-domain relationship between the first semi-statically configured resource and the second resource.

Aspect 8: The method of Aspect 5, wherein the second cell is a reference cell, and wherein performing at least one of the first communication or the second communication according to the intra-band conflict resolution rule further comprises performing a selected communication, of the first communication or the second communication, associated with a higher priority of the first priority or the second priority.

Aspect 9: The method of Aspect 8, further comprising dropping a communication, of the first communication or the second communication, associated with a lower priority of the first priority or the second priority.

Aspect 10: The method of any of Aspects 1-9, wherein the first priority satisfies a threshold, the second resource is configured, by a cell-common time division duplexing (TDD) configuration or a RRC dedicated TDD configuration, for the second link direction, the second cell is a reference cell, and performing at least one of the first communication or the second communication further comprises transmitting the first communication based at least in part on the first priority satisfying the threshold.

Aspect 11: The method of Aspect 10, wherein the second communication is not scheduled or configured on the second resource.

Aspect 12: The method of any of Aspects 1-11, wherein the capability for the intra-band conflict resolution rule is specific to half-duplex communication, and wherein the first cell and the second cell are configured for sub-band full duplex intra-band carrier aggregation.

Aspect 13: A method of wireless communication performed by a user equipment (UE), comprising: receiving information indicating a first resource for measurement of a synchronization signal block (SSB) on a first cell, wherein the first resource at least partially overlaps with a second resource, on a second cell belonging to a same band as the first cell, indicated for an uplink transmission of the UE; and transmitting, in half-duplex, the uplink transmission on the second resource.

Aspect 14: The method of Aspect 13, wherein transmitting, in half-duplex, the uplink transmission on the second resource further comprises transmitting the uplink transmission without having measured the SSB in the first cell.

Aspect 15: The method of Aspect 14, further comprising skipping measurement of the SSB on the first resource based at least in part on having previously acquired the SSB using a first beam, wherein the first resource is associated with a second beam different than the first beam.

Aspect 16: The method of any of Aspects 13-15, further comprising transmitting an indication that the UE has not measured the SSB on the first cell.

Aspect 17: The method of any of Aspects 13-16, further comprising transmitting measurement information relating to a prior transmission of the SSB, wherein the prior transmission is associated with a same SSB index as the SSB associated with the first resource.

Aspect 18: The method of any of Aspects 13-17, wherein the uplink transmission is associated with a dynamic grant.

Aspect 19: The method of any of Aspects 13-18, wherein the uplink transmission is associated with a configured grant.

Aspect 20: The method of any of Aspects 13-19, wherein the uplink transmission is a physical uplink shared channel (PUSCH) transmission or a physical uplink control channel (PUCCH) transmission.

Aspect 21: A method of wireless communication performed by a network node, comprising: obtaining capability information indicating that a user equipment (UE) has a capability for an intra-band conflict resolution rule for resolving a conflict, in at least one symbol, between a first communication on a first semi-statically configured resource of a first cell and a second resource on a second cell based at least in part on a first priority of the first communication, the first semi-statically configured resource having a first link direction and the second resource having a second link direction different than the first link direction; and performing at least one of the first communication or a second communication on the second resource according to the intra-band conflict resolution rule.

Aspect 22: The method of Aspect 21, wherein the second resource is semi-statically configured for transmission or reception of at least one of: a physical uplink control channel, a physical uplink shared channel, a sounding reference signal, a physical random access channel, a physical downlink control channel, a physical downlink shared channel, or a channel state information reference signal.

Aspect 23: The method of any of Aspects 21-22, wherein the second resource is configured, by a cell-common time division duplexing (TDD) configuration or a dedicated TDD configuration, for the second link direction.

Aspect 24: The method of any of Aspects 21-23, wherein performing at least one of the first communication or the second communication on the second resource according to the intra-band conflict resolution rule further comprises performing at least one of the first communication or the second communication based at least in part on a second priority associated with the second communication or the second resource.

Aspect 25: The method of Aspect 24, wherein the first cell is a reference cell, the second priority is higher than the first priority, and performing at least one of the first communication or the second communication further comprises obtaining the second communication and dropping the first communication based at least in part on the second priority being higher than the first priority.

Aspect 26: The method of Aspect 25, wherein the second resource is semi-statically configured for transmission or reception of a channel or signal.

Aspect 27: The method of Aspect 25, wherein at least one of the first priority or the second priority is based at least in part on at least one of: a physical channel priority, a logical channel priority, a quality of service requirement, a signal type, a channel type, a content of the first communication or the second communication, a time-domain behavior, or a time-domain relationship between the first semi-statically configured resource and the second resource.

Aspect 28: The method of Aspect 25, wherein the second cell is a reference cell, and wherein performing at least one of the first communication or the second communication according to the intra-band conflict resolution rule further comprises performing a selected communication, of the first communication or the second communication, associated with a higher priority of the first priority or the second priority.

Aspect 29: The method of Aspect 28, further comprising dropping a communication, of the first communication or the second communication, associated with a lower priority of the first priority or the second priority.

Aspect 30: The method of Aspect 21, wherein the first priority satisfies a threshold, the second resource is configured, by a cell-common time division duplexing (TDD) configuration or a dedicated TDD configuration, for the second link direction, the second cell is a reference cell, and performing at least one of the first communication or the second communication further comprises performing the first communication based at least in part on the first priority satisfying the threshold.

Aspect 31: The method of Aspect 30, wherein the second communication is not scheduled or configured on the second resource.

Aspect 32: The method of Aspect 21, wherein the capability for the intra-band conflict resolution rule is specific to half-duplex communication, and wherein the first cell and the second cell are configured for sub-band full duplex intra-band carrier aggregation.

Aspect 33: A method of wireless communication performed by a network node, comprising: outputting information indicating a first resource for measurement of a synchronization signal block (SSB) on a first cell, wherein the first resource at least partially overlaps with a second resource, on a second cell belonging to a same band as the first cell, indicated for an uplink transmission of a user equipment (UE); and obtaining the uplink transmission on the second resource.

Aspect 34: The method of Aspect 33, further comprising obtaining an indication that the UE has not measured the SSB on the first cell.

Aspect 35: The method of any of Aspects 33-34, further comprising obtaining measurement information relating to a prior transmission of the SSB, wherein the prior transmission is associated with a same SSB index as the SSB associated with the first resource.

Aspect 36: The method of any of Aspects 33-35, wherein the uplink transmission is associated with a dynamic grant.

Aspect 37: The method of any of Aspects 33-36, wherein the uplink transmission is associated with a configured grant.

Aspect 38: The method of any of Aspects 33-37, wherein the uplink transmission is a physical uplink shared channel (PUSCH) transmission or a physical uplink control channel (PUCCH) transmission.

Aspect 39: An apparatus for wireless communication at a device, comprising a processor; memory coupled with the processor; and instructions stored in the memory and executable by the processor to cause the apparatus to perform the method of one or more of Aspects 1-38.

Aspect 40: A device for wireless communication, comprising a memory and one or more processors coupled to the memory, the one or more processors configured to perform the method of one or more of Aspects 1-38.

Aspect 41: An apparatus for wireless communication, comprising at least one means for performing the method of one or more of Aspects 1-38.

Aspect 42: A non-transitory computer-readable medium storing code for wireless communication, the code comprising instructions executable by a processor to perform the method of one or more of Aspects 1-38.

Aspect 43: A non-transitory computer-readable medium storing a set of instructions for wireless communication, the set of instructions comprising one or more instructions that, when executed by one or more processors of a device, cause the device to perform the method of one or more of Aspects 1-38.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit capability information indicating that the UE has a capability for an intra-band conflict resolution rule for resolving a conflict, in at least one symbol, between a first communication on a first semi-statically configured resource of a first cell and a second resource on a second cell based at least in part on a first priority of the first communication, the first semi-statically configured resource having a first link direction and the second resource having a second link direction different than the first link direction; and
perform at least one of the first communication or a second communication on the second resource according to the intra-band conflict resolution rule.

2. The UE of claim 1, wherein the second resource is semi-statically configured for transmission or reception of at least one of:
a physical uplink control channel,
a physical uplink shared channel,
a sounding reference signal,
a physical random access channel,
a physical downlink control channel,
a physical downlink shared channel, or
a channel state information reference signal.

3. The UE of claim 1, wherein the second resource is configured, by a cell-common time division duplexing (TDD) configuration or a dedicated TDD configuration, for the second link direction.

4. The UE of claim 1, wherein the one or more processors, to perform at least one of the first communication or the second communication on the second resource according to the intra-band conflict resolution rule, are configured to perform at least one of the first communication or the second communication based at least in part on a second priority associated with the second communication or the second resource.

5. The UE of claim 4, wherein the first cell is a reference cell, the second priority is higher than the first priority, and performing at least one of the first communication or the second communication further comprises transmitting the second communication and dropping the first communication based at least in part on the second priority being higher than the first priority.

6. The UE of claim 4, wherein the second resource is semi-statically configured for transmission or reception of a channel or signal.

7. The UE of claim 4, wherein at least one of the first priority or the second priority is based at least in part on at least one of:
a physical channel priority,
a logical channel priority,
a quality of service requirement,
a signal type,
a channel type,
a content of the first communication or the second communication,
a time-domain behavior, or
a time-domain relationship between the first semi-statically configured resource and the second resource.

8. The UE of claim 4, wherein the second cell is a reference cell, and wherein performing at least one of the first communication or the second communication according to the intra-band conflict resolution rule further comprises performing a selected communication, of the first communication or the second communication, associated with a higher priority of the first priority or the second priority.

9. The UE of claim 8, wherein the one or more processors are further configured to drop a communication, of the first communication or the second communication, associated with a lower priority of the first priority or the second priority.

10. The UE of claim 1, wherein the first priority satisfies a threshold, the second resource is configured, by a cell-common time division duplexing (TDD) configuration or a RRC dedicated TDD configuration, for the second link direction, the second cell is a reference cell, and performing at least one of the first communication or the second communication further comprises transmitting the first communication based at least in part on the first priority satisfying the threshold.

11. The UE of claim 10, wherein the second communication is not scheduled or configured on the second resource.

12. The UE of claim 1, wherein the capability for the intra-band conflict resolution rule is specific to half-duplex communication, and wherein the first cell and the second cell are configured for sub-band full duplex intra-band carrier aggregation.

13. A user equipment (UE) for wireless communication, comprising:
a memory; and
one or more processors, coupled to the memory, configured to:
receive information indicating a first resource for measurement of a synchronization signal block (SSB) on a first cell, wherein the first resource at least partially overlaps with a second resource, on a second cell belonging to a same band as the first cell, indicated for an uplink transmission of the UE; and
transmit, in half-duplex, the uplink transmission on the second resource.

14. The UE of claim 13, wherein the one or more processors, to transmit, in half-duplex, the uplink transmission on the second resource, are configured to transmit the uplink transmission without having measured the SSB in the first cell.

15. The UE of claim 14, wherein the one or more processors are further configured to skip measurement of the SSB on the first resource based at least in part on having previously acquired the SSB using a first beam, wherein the first resource is associated with a second beam different than the first beam.

16. The UE of claim 13, wherein the one or more processors are further configured to transmit an indication that the UE has not measured the SSB on the first cell.

17. The UE of claim 13, wherein the one or more processors are further configured to transmit measurement information relating to a prior transmission of the SSB, wherein the prior transmission is associated with a same SSB index as the SSB associated with the first resource.

18. The UE of claim 13, wherein the uplink transmission is associated with a dynamic grant.

19. The UE of claim 13, wherein the uplink transmission is associated with a configured grant.

20. The UE of claim 13, wherein the uplink transmission is a physical uplink shared channel (PUSCH) transmission or a physical uplink control channel (PUCCH) transmission.

21. A network node for wireless communication, comprising:
a memory; and
one or more processors, coupled to the memory, configured to:
obtain capability information indicating that a user equipment (UE) has a capability for an intra-band conflict resolution rule for resolving a conflict, in at least one symbol, between a first communication on a first semi-statically configured resource of a first cell and a second resource on a second cell based at least in part on a first priority of the first communication, the first semi-statically configured resource having a first link direction and the second resource having a second link direction different than the first link direction; and
perform at least one of the first communication or a second communication on the second resource according to the intra-band conflict resolution rule.

22. The network node of claim 21, wherein the second resource is semi-statically configured for transmission or reception of at least one of:
a physical uplink control channel,
a physical uplink shared channel,
a sounding reference signal,
a physical random access channel,
a physical downlink control channel,
a physical downlink shared channel, or
a channel state information reference signal.

23. The network node of claim 21, wherein the one or more processors, to perform at least one of the first communication or the second communication on the second resource according to the intra-band conflict resolution rule, are configured to perform at least one of the first communication or the second communication based at least in part on a second priority associated with the second communication or the second resource.

24. The network node of claim 23, wherein the first cell is a reference cell, the second priority is higher than the first priority, and performing at least one of the first communication or the second communication further comprises obtaining the second communication and dropping the first communication based at least in part on the second priority being higher than the first priority.

25. The network node of claim 23, wherein the second resource is semi-statically configured for transmission or reception of a channel or signal.

26. The network node of claim 23, wherein at least one of the first priority or the second priority is based at least in part on at least one of:
a physical channel priority,
a logical channel priority,
a quality of service requirement,
a signal type,
a channel type,
a content of the first communication or the second communication,
a time-domain behavior, or
a time-domain relationship between the first semi-statically configured resource and the second resource.

27. The network node of claim 23, wherein the second cell is a reference cell, and wherein performing at least one of the first communication or the second communication according to the intra-band conflict resolution rule further comprises performing a selected communication, of the first communication or the second communication, associated with a higher priority of the first priority or the second priority.

28. The network node of claim 21, wherein the capability for the intra-band conflict resolution rule is specific to half-duplex communication, and wherein the first cell and the second cell are configured for sub-band full duplex intra-band carrier aggregation.

29. A network node for wireless communication, comprising:
a memory; and
one or more processors, coupled to the memory, configured to:
output information indicating a first resource for measurement of a synchronization signal block (SSB) on a first cell, wherein the first resource at least partially overlaps with a second resource, on a second cell belonging to a same band as the first cell, indicated for an uplink transmission of a user equipment (UE); and
obtain the uplink transmission on the second resource.

30. The network node of claim 29, wherein the one or more processors are further configured to obtain an indication that the UE has not measured the SSB on the first cell.
